(19) United States
(12) Patent Application Publication
(10) Pub. No.: US 2013/0290188 A1
(43) Pub. Date: Oct. 31, 2013

(54) System and Method for Approving Payments

(71) Applicant: Hugh Olliphant, Piedmont, CA (US)

(72) Inventor: Hugh Olliphant, Piedmont, CA (US)

(21) Appl. No.: 13/871,966

(22) Filed: Apr. 26, 2013

Related U.S. Application Data
(60) Provisional application No. 61/639,767, filed on Apr. 27, 2012.

(51) Int. Cl. G06Q 20/40

(52) U.S. Cl. CPC G06Q 20/405
USPC 705/44

(57) ABSTRACT

A server system including one or more processors and memory obtains a payment instrument associated with a user. The server system sends, to a client associated with the user, an electronic calendar object corresponding to a respective date, where the electronic calendar object is associated with a fee and receives a user response to the electronic calendar object. In response to receiving the user response to the electronic calendar object, in accordance with a determination that the user response includes an acceptance of the electronic calendar object, the server system stores authorization information indicating that the user has authorized the fee to be paid using the payment instrument. In some implementations, the electronic calendar object includes an invitation to an event, the respective date is an event date on which the event is scheduled to occur, and the fee is an event fee associated with the event.

### RELATED APPLICATIONS

This application claims priority to U.S. Provisional Patent Application Ser. No. 61/639,767, filed Apr. 27, 2012, entitled “System and Method for Approving Payments,” which is incorporated herein by reference in its entirety.

### TECHNICAL FIELD

The claimed system and method relate generally to the field of approving payments.

### BACKGROUND

Group organizers create communities around topics such as professional or geographic affiliations. These organizers have expressed a need for services that make it easy for them to create events such as breakfasts, lunches, dinners, and happy hours.

### SUMMARY OF EMBODIMENTS

The above deficiencies and other problems associated with coordinating events between a plurality of event participants are addressed by the system and method disclosed herein for automating the scheduling of periodic meetings, such as lunches, with contacts and colleagues. This automation includes automation of one or more of selecting a venue, scheduling events, managing RSVPs, and collecting payments. For some embodiments of the invention, the periodic meetings include other types of social occasions, such as dinners, breakfasts, brunches, coffee dates, happy hours, nights on the town, children's play dates, or any other periodic activity where it is convenient to have events automatically scheduled (e.g., in situations where complex logistics make planning difficult). In some embodiments periodic meetings are arranged between the user and parties unknown to the user based on common interests (e.g., political groups and alumni groups). In some embodiments, in order to more fully automate the scheduling of these meetings, the disclosed system and method takes into account factors such as when the participants (e.g., the user and the contacts of the user who are invited to the event) are available, what the participants' travel preferences are, preferences for a particular location, and how frequently the users desire to see each other.

In some embodiments, a method is performed at a server system having one or more processors and memory storing one or more programs for execution by the one or more processors so as to perform the method. The method includes obtaining a payment instrument associated with a user and sending, to a client associated with the user, an electronic calendar object corresponding to a respective date, where the electronic calendar object is associated with a fee. The method further includes receiving a user response to the electronic calendar object and in response to receiving the user response to the electronic calendar object, in accordance with a determination that the user response includes an acceptance of the electronic calendar object, storing authorization information indicating that the user has authorized the fee to be paid using the payment instrument.

In accordance with some embodiments, a computer system (e.g., a server system) includes one or more processors, memory, and one or more programs; the one or more programs are stored in the memory and configured to be executed by the one or more processors and the one or more programs include instructions for performing the operations of the method described above. In accordance with some embodiments, a non-transitory computer readable storage medium has stored therein instructions which when executed by one or more processors, cause a computer system (e.g., a server system) to perform the operations of the methods described above.

### BRIEF DESCRIPTION OF THE DRAWINGS

For a better understanding of the disclosed embodiments, reference should be made to the Description of Embodiments below, in conjunction with the following drawings in which like reference numerals refer to corresponding parts throughout the figures.

FIG. 1 is an overview of a distributed client-server system, in accordance with some embodiments.

FIG. 2 is a block diagram illustrating a scheduling server, in accordance with some embodiments.

FIG. 3 is a block diagram illustrating a client, in accordance with some embodiments.

FIGS. 4A-4B include a flow diagram illustrating a process for automatically scheduling events, in accordance with some embodiments.

FIGS. 5A-5W illustrate example user interfaces for event scheduling, in accordance with some embodiments.

FIGS. 6A-6C include a flow diagram illustrating a process for authorizing or scheduling payments, in accordance with some embodiments.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the embodiments. However, it will be apparent to one of ordinary skill in the art that the embodiments may be practiced without these specific details. In other instances, well-known methods, procedures, components, and circuits have not been described in detail so as not to unnecessarily obscure aspects of the embodiments.

It will also be understood that, although the terms “first,” “second,” etc. are used herein to describe various elements, these elements should not be limited by these terms. These terms are only used to distinguish one element from another. For example, a first entity could be termed a second entity, and, similarly, a second entity could be termed a first entity, without changing the meaning of the description, so long as all occurrences of the “first entity” are renamed consistently and all occurrences of the second entity are renamed consistently. The first entity and the second entity are both entities, but they are not the same entity.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can, optionally be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” should be construed to mean “upon determining” or “in response to determining” or “in accordance with a determination” or “upon detecting” or “in response to detecting” that the stated condition precedent is true, depending on the context.

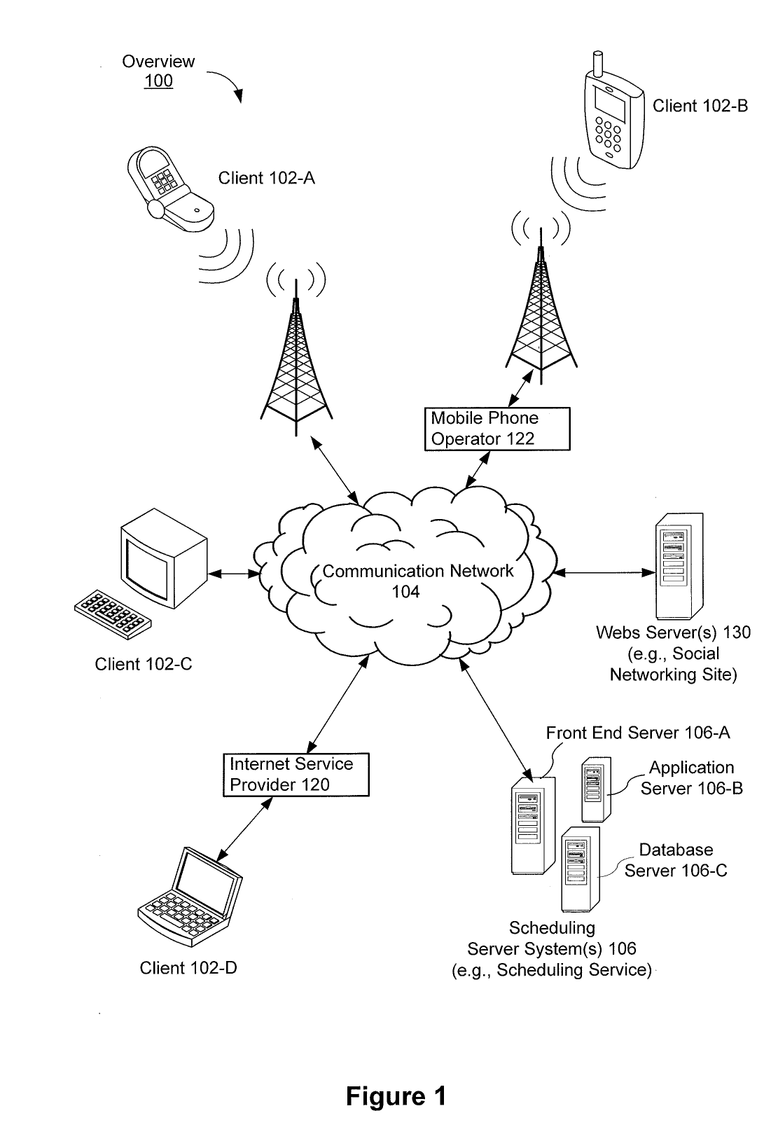

Attention is now directed to FIG. 1, which illustrates the infrastructure of a client-server distributed system 100 according to some embodiments. The distributed system 100 includes a plurality of clients 102 A-D and one or more scheduling server systems 106 (e.g., “scheduling server 106”) one or more internet service providers 120, one or more mobile phone operators 122, and one or more web servers 130 (e.g., social networking sites). These components are linked together through one or more communication networks 104 (e.g., the Internet, other wide area networks, local area network, etc.) so that the various components can communicate with each other.

A client system 102 (e.g., client 102) may be any computer or similar device that is capable of receiving from the scheduling server 106 data (e.g., web pages, electronic messages, emails, calendar invitations), displaying data, and sending requests (e.g., web page requests, search queries, information requests, login requests, etc.) to the scheduling server 106, the internet service provider 120, the mobile phone operator 122, or the web server 130. Examples of suitable clients 102 include, without limitation, desktop computers, notebook computers, tablet computers, mobile devices such as mobile phones, personal digital assistants, and set-top boxes. In some embodiments, the term “web page” means any data (e.g., text, image, audio, video, java scripts, etc.) that may be used by a web browser or other client application programs. In some embodiments a web page includes one or more web applications (e.g., an executable application that can be accessed through a web browser over a network).

Requests and other information from a client may be conveyed to a respective scheduling server 106 using the http protocol (e.g., by using http requests). In some embodiments, the clients 102 may be connected to the communication network using cables such as wires, optical fibers and other transmission mediums. In other embodiments, the clients 102 may be connected to the communication network through one or more wireless networks using radio signals or the like.

In some embodiments, the one or more scheduling servers 106 (e.g., facilitating a scheduling service) comprise a single server. In other embodiments the scheduling servers 106 include a plurality of servers, such as a front end server 106-A one or more application servers 106-B and one or more database servers 106-C which are connected to each other through a network (e.g., a LAN, WAN or the like) and exchange information with the clients 102 through a common interface (e.g., front end server 106-A). In some embodiments, the servers are located at different locations. The front end server 106-A parses requests from the clients 102, fetches corresponding web pages, electronic messages or other data from the application server 106-B and returns the web pages, electronic messages or other data to the requesting client(s) 102. Depending upon their respective locations in the topology of the client-server system, the front end server 106-A and the application server 106-B are merged into one software application and/or hosted on one physical server.

The distributed system may also include one or more additional components that are connected to the servers systems 106 and the clients 102 through the communication network 104. In some embodiments, the internet service provider 120 provides one or more of the clients 102 with access to the communication network 104. In some embodiments the internet service provider 120 provides a user of one of the clients 102 with one or more network communication accounts (e.g., email accounts). The mobile phone operator 122 provides access to the communication network 104 to various clients 102 (e.g., through a proprietary cell phone network).

In some embodiments, the web server 130 is a social networking website, or the like. In these embodiments, a user of one of the clients 102 has an account with the social networking website including at least a unique user identifier. In accordance with some embodiments, information gathered from the social networking site is used to assist in automatically scheduling events by the scheduling server 106. Events are time based occurrences that include at least one participant. Events are also commonly referred to as “appointments.” If an event has multiple participants, it is sometimes referred to as a “meeting” or a “conference.” For example, in some embodiments the connection of a user to various contacts through one or more social networking websites are analyzed by the scheduling server 106 and used to automatically select participants for a proposed event. Additionally, information such as the number of social connections of the user to a contact in the user's social network or the location of a user or a contact of the user may be acquired from the social networking website and be used by the scheduling server 106 to determine whether the contact should be a participant in the event. In some embodiments the web server 130 is an event location rating website (e.g., YELP) and is used to select a location for a proposed event. For example, in some embodiments, restaurant reviews are taken from a restaurant review website and used to determine the location for a meal-time event (e.g., a lunch). In some implementations, participants in an event can authorize the scheduling server 106 to process payments for an event by accepting a calendar invitation to the event.

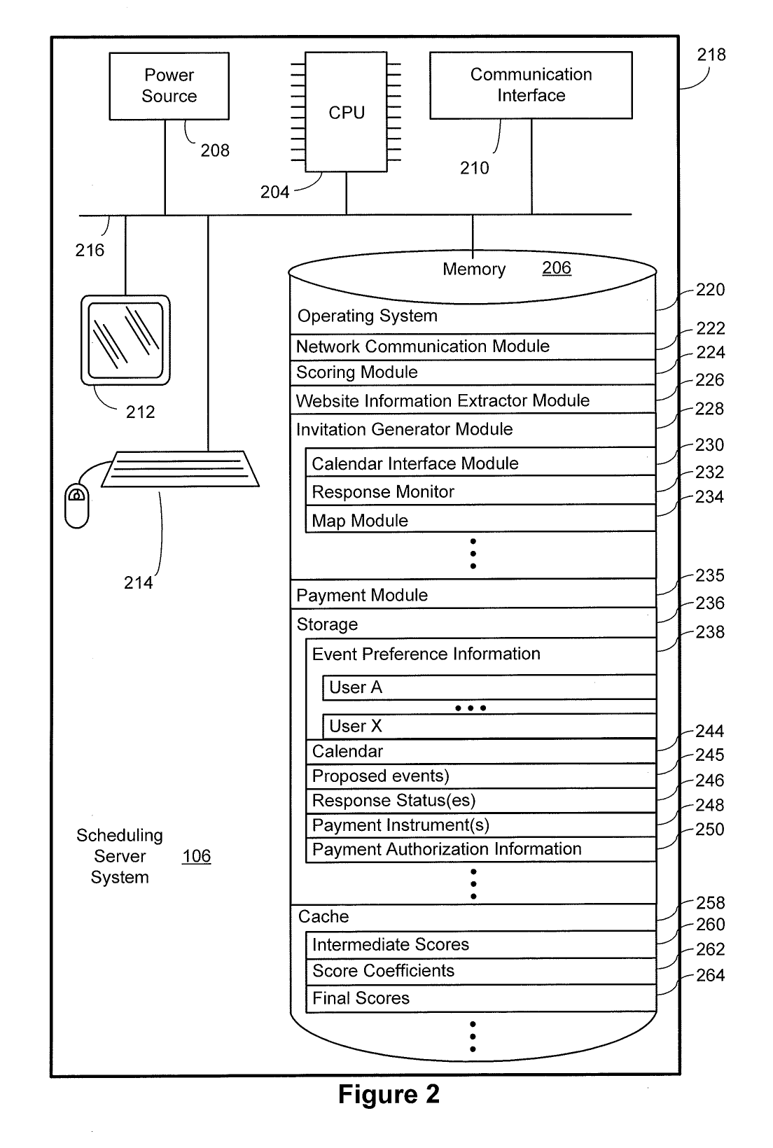

FIG. 2 is a block diagram illustrating a scheduling server system 106 (e.g., “scheduling server 106”) in accordance with one embodiment. The scheduling server 106 typically includes one or more processing units (e.g., CPUs) 204, one or more power sources 208, one or more network or other communications interfaces 210, memory 206, one or more communication buses 216 for interconnecting these components, and a housing 218. The scheduling server 106 optionally includes a user interface comprising a display device 212 and/or a keyboard, a mouse 214, and/or a touch-sensitive surface such as a touch screen display. Memory 206 optionally includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 206 may optionally include one or more storage devices remotely located from the one or more CPUs 204. Memory 206, or alternately the non-volatile memory device(s) within the memory 206, comprises a computer readable storage medium. In some embodiments, the memory 206 or the computer readable storage medium of memory 206 stores the following programs, modules and data structures, or any subset thereof:
An operating system 220 that includes procedures for handling various basic system services and for performing hardware dependent tasks.
A network communication module 222 that is used for connecting the scheduling server 106 to other computers via the communication network interfaces 210 (wired or wireless) and one or more communication networks, such as the Internet, other wide area networks, local area networks, metropolitan area networks, and so on.
A scoring module 224 that is used for ranking and selecting various ones of: a time, a location and participants for a respective event.
A website information extractor module 226, for retrieving information about a respective user from websites that include information about the user, including participant preferences (e.g., from a social networking website) and location preferences (e.g., from a restaurant rating website). For example, the website information extractor may operate by getting contacts from FACEBOOK and getting food preferences from YELP.
An invitation generator module 228 for generating electronic messages including an invitation to one or more proposed events(s). In some embodiments the invitation generator module 228 includes one or more of the following modules: a calendar interface module 230 for creating electronic event invitations in a file compliant with the .ics or .vcs calendaring information format standards (e.g., by creating/sending OUTLOOK events); a response monitor 232 for monitoring the number of confirmed attendees and sending reminders, confirmations and cancellations, as discussed in greater detail below; and a map module 234 for providing directions from the location of a user to the location of the event.
A payment module 235 for obtaining payment information from participants, organizers and venues, adding information corresponding to payment options to electronic calendar objects, storing payment authorization information, processing payments in accordance with stored payment authorization information and providing information to participants, organizers and venues concerning payments for events.
Storage 236 for storing event preference information for users 238, including time/date availability, activity preferences, typical locations and/or location preferences, payment preferences, rankings of contacts and travel preferences, calendar information 244, proposed events 245, the response statuses 246 of participants for the proposed events 245, payment instrument(s) 248 for participants in events, and payment authorization information 250 indicative of events for which a user has authorized payments to be processed.
A cache 258 for storing data such as intermediate scores 260 that are calculated while the scoring module is selecting a time, location or participants for a respective event, as well as score coefficients 262 for selectively weighting the intermediate scores as described in greater detail below and final scores 264 determined base on the intermediate scores and the score coefficients.

Each of the above identified elements are, optionally, stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules are, optionally, combined or otherwise re-arranged in various embodiments. In some embodiments, Memory 206 optionally stores a subset of the modules and data structures identified above. Furthermore, Memory 206 optionally stores additional modules and data structures not described above.

Although FIG. 2 shows a scheduling server 106 (e.g., “server system 106”), FIG. 2 is intended more as functional description of the various features which are, optionally, present in a set of servers than as a structural schematic of the embodiments described herein. In practice, and as recognized by those of ordinary skill in the art, items shown separately could be combined and some items could be separated. For example, some items shown separately in FIG. 2 could be implemented on single servers and single items could be implemented by one or more servers. The actual number of servers used to implement server system 106 and how features are allocated among them will vary from one implementation to another, and optionally depends in part on the amount of data traffic that the system must handle during peak usage periods as well as during average usage periods.

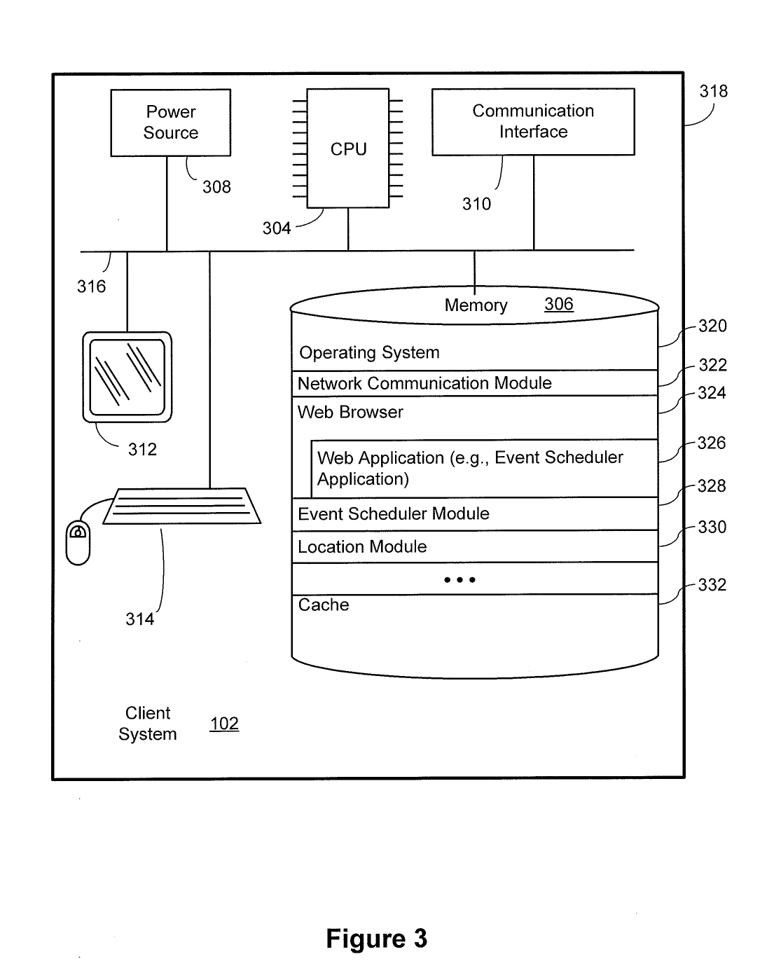

FIG. 3 is a block diagram illustrating a client system 102 (e.g., “client 102”) in accordance with one embodiment. The client 102 typically includes one or more processing units (CPUs) 304, one or more power sources 308, one or more network or other communications interfaces 310, memory 306, one or more communication buses 316 for interconnecting these components, and a housing 318. The client 102 optionally may include a user interface devices including a display device 312 and a keyboard and mouse 314 or a touch sensitive surface. The memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 306 may optionally include one or more storage devices remotely located from the CPU(s) 304. The memory 306, or alternately the non-volatile memory device(s) within the memory 306, comprises a computer readable storage medium. In some embodiments, the memory 306 or the computer readable storage medium of the memory 306 stores one or more of the following programs, modules and data structures, or a subset thereof:
An operating system 320 that includes procedures for handling various basic system services and for performing hardware dependent tasks.
A network communication module 322 that is used for connecting the client 102 to other computers via the one or more communication network interfaces 310 (wired or wireless) and one or more communication networks, such as the Internet, other wide area networks, local area networks, metropolitan area networks, and so on.
A web browser 324, for receiving a user request for a web page and rendering the requested web page on the display device 312 or other user interface device, in some embodiments the web browser includes a web application 326 for the execution of event scheduling tasks.
An event scheduler module 328 for the execution of event scheduling tasks (e.g., a locally stored application instead of a web application such as MICROSOFT's OUTLOOK calendaring program).
A location module 330 for detecting the location of the client (e.g., using a global positioning system module) and periodically reporting the location of the client to the scheduling server (e.g., sending the scheduling server the location of the client at a typical lunch time, so that the scheduling server can use that information when scheduling a lunch event for the user).
A cache 332 for temporarily storing information (e.g., storing location information before it is sent to the scheduling server).

Each of the above identified elements are, optionally, stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules are, optionally, combined or otherwise re-arranged in various embodiments. In some embodiments, Memory 306 optionally stores a subset of the modules and data structures identified above. Furthermore, Memory 306 optionally stores additional modules and data structures not described above.

### Event Preference Information

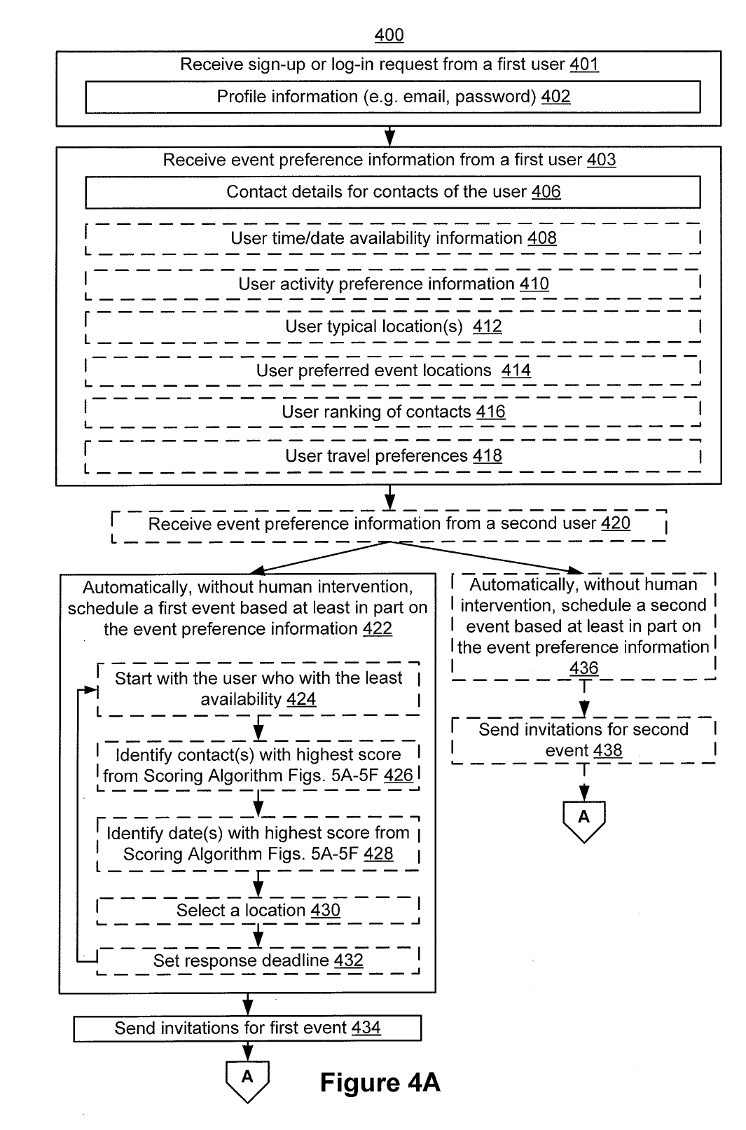

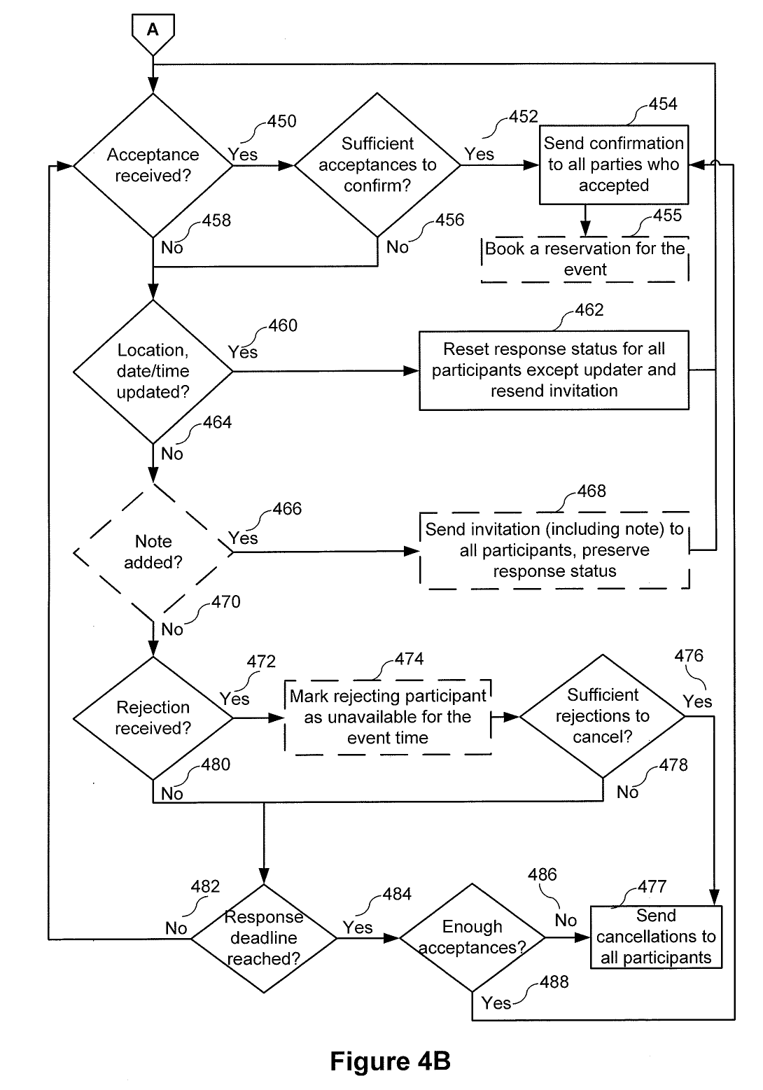

FIGS. 4A-4B include a flowchart representing a method 400 for automatically scheduling events, according to certain embodiments. Method 400 is, optionally, governed by instructions that are stored in a non-transitory computer readable storage medium and that are executed by one or more processors of one or more servers (e.g., scheduling server 106, FIG. 2). Each of the operations shown in FIGS. 4A-4B typically corresponds to instructions stored in a computer memory or non-transitory computer readable storage medium (e.g., memory 206 of scheduling server 106 in FIG. 2). The computer readable storage medium optionally includes a magnetic or optical disk storage device, solid state storage devices such as Flash memory, or other non-volatile memory device or devices. The computer readable instructions stored on the computer readable storage medium optionally includes one or more of: source code, assembly language code, object code, or other instruction format that is executed or interpreted by one or more processors. In various embodiments, some operations in method 400 are optionally combined and/or the order of some operations are optionally changed from the order shown in FIGS. 4A-4B.

A scheduling server 106 receives (401) sign-up or log-in request from a client 102 associated with a first user. A sign-up request is a request from a new user to create a user account with the scheduling server 106. A log-in request is a request from a returning user who has already signed up to access a previously created account with the scheduling server 106. In some embodiments the client 102 is a computing device associated with a user (e.g., a cell phone or a personal digital assistant) in some embodiments the client 102 includes an instance of a client application (e.g., a web application or a locally stored application) that the associated user is logged into.

In some embodiments, sign-up or log-in request includes profile information (404) (e.g., a unique user identifier such as an email address and password associated with an account of the user on the server system). In some embodiments, the user also provides multiple identifiers including one or more emails, one or more phone numbers, or one or more third party usernames to services such as SKYPE, YAHOO INSTANT MESSENGER, and other communication channels. The server system may use these identifiers to access web servers associated with the third party services and acquire information about the user including information about the user's contacts, location or dining preferences. Alternatively, the scheduling server may also rely on identity services such as FACEBOOK CONNECT in order to uniquely identify the user.

In some embodiments the scheduling server 106 receives (403) event preference information from the client 102 associated with the first user. The event preference information also includes contact details (406) for one or more contacts of the first user. In some embodiments, the user identifies contacts (e.g., friends, colleagues, professional contacts, and other individuals) with whom the user would like to remain in touch by having periodic events (e.g., lunches). This process may include any of the following: 1) collecting email addresses manually typed in by the user, or 2) allowing the user to provide credentials to an online address book, email program, or social network, then allowing the user to select contacts from that service, or 3) allowing the user to select contacts stored within the client, such as an OUTLOOK contacts program or mobile phone address book. In an alternative embodiment, the user may provide the phone numbers of contacts and colleagues instead of entering email addresses.

In some embodiments, all of the event preference information is gathered directly from the user (e.g., entered by the user into an event scheduling website or client application). It should be understood that event preference information is information that is helpful in scheduling a meeting (e.g., availability, location preferences, participant preferences). In contrast, event scheduling information for a particular event includes the precise date, participants and location for a specific event (i.e., a request to schedule a lunch with a friend next Tuesday).

In some embodiments, at least a subset of the event preference information is gathered from one or more additional sources other than the user. For example, the user could enter profile information (e.g., a unique user identifier and a password) for one or more web services (e.g., email, social networking websites, restaurant ranking websites) and the scheduling server will access those websites and determine the contacts of the user, the ranking of contacts of the user, and the ranking of restaurants by the user. At least a subset of the information acquired from third party web services is used by the scheduling server to select times, locations and participants for an event that are desirable for the user.

In accordance with some embodiments, the event preference information 238 includes additional information that is useful for scheduling events, such as information from one or more of the following categories:

User data/time availability information (408) (e.g., the times of day and/or days of the week that the user is typically available or the times and dates when the user is available for events) including at least a plurality of times when the user is available. In some embodiments availability for events is indicated by any date/time that has not been marked by a user as “unavailable.” In some embodiments, the user indicates what their availability will be for an event (e.g., a lunch event). If the scheduling server does not yet have the user's time zone and it is unable to determine this information from the client associated with the user, then it will solicit this information from the user. The plurality of times when the user is available may be represented as a periodic interval such as “every other Wednesday,” the user may also select individual dates and times when they will be available for an event.

In some embodiments, a first user accesses the scheduling server and provides (402) event preference information to the scheduling server. In response to the receiving event preference information from the first user, the scheduling server sends an electronic message to the first user including a placeholder calendar entry based at least in part on the event preference information provided by the first user (e.g., for a date/time when the first user is available). If the first user uses an electronic calendar which supports the veal format, such as OUTLOOK, GOOGLE CALENDAR, or APPLE ICAL, then placeholders are sent by the scheduling server 106 to the user's electronic calendar via a multipart email or text message which includes a veal or ical attachment. The veal or ical in the electronic message allows the electronic calendar to automatically update the user's calendar with the event placeholder information. These placeholders ensure that the user's event date/time is reserved. The user may also indicate that they do not use an electronic calendar, in which case, no placeholders are sent.

In some embodiments, the user allows the scheduling server to view their online event calendar in order to facilitate or automate the availability selection. In some embodiments, the calendar sharing is enabled through one or more of the following methods, including: (1) a user sharing their authentication credentials for their online calendar, (2) a user installing a client-side program such as an OUTLOOK plug-in, (3) the user enabling sharing with the scheduling server from within their calendar program, or (4) a user setting his electronic calendar to publish or broadcast his availability to the scheduling server 106. Additionally, if a user's electronic calendar reveals the availability of contacts of the user (e.g., friends and colleagues), then the scheduling server 106 can use this information to populate information about the user's contact. For example, an OUTLOOK plug-in may be designed such that the plug-in accesses the availability of work colleagues on a common MICROSOFT Exchange Server. As another example, some of the user's contacts may share their availability with the user through GOOGLE CALENDAR's sharing functionality; in these cases, the scheduling server may analyze the availability of those contacts. The user's availability is considered by the scoring process.

User activity preference information (410) (e.g., the types of activities that the user enjoys). In some embodiments, the user provides information about the user's interests in addition to, or instead of, providing a list of contacts as listed above. The scheduling server may request specific information from the user, or may ask the user to give permission and any necessary authentication credentials so that the scheduling server may collect or infer the user's interests from an online service, such as a social networking website. Interests may include things such as dating, profession-related interests, hobbies, and the like. The user's interests are considered by the scoring process.

User typical location(s) (412) (e.g., the usual location of the user at lunch time). In accordance with some embodiments, the user provides information about where the user is typically located at different times in the day or days in the week (e.g., the location of their workplace at lunchtime). Alternatively, if the user is using the scheduling server through a client which supports location-awareness, such as an IPHONE with GPS, then the scheduling server may infer the user's location information using the GPS information. The scheduling server may support more than one location for the user. For example, if the location information provided either by the user or the client indicates that the user typically spends Fridays working from home, then the scheduling server will propose lunches on Fridays which are closer to the user's home. The user's location or locations are considered by the scoring process.

User preferred event location(s) (414) (e.g., restaurants where the user likes to eat lunch). In some embodiments, the scheduling server will retrieves a list of restaurants near the user's location and ask the user to indicate their desire to eat at these establishments. Information on nearby restaurants may be provided by a service such as YELP or GOOGLE LOCAL. The scheduling server may allow the user to retrieve their restaurant preferences with another service where the user may have rated and reviewed restaurants, such as YELP. For example, assume that a given user has actively used the YELP service to rate restaurants in her area. The user provides a YELP username, which the scheduling server can use to extract the user's restaurant ratings from the YELP website. If the restaurant rating service provides other means to access its user's ratings, such as an Application Programming Interface (API), then the scheduling server may use those other means as well. The user's preferred event locations are considered by the scoring process.

User ranking of contacts (416) such as by specifying a desired event frequency (e.g., how frequently the user would like to meet each of his or her contacts for lunch). In some embodiments, the scheduling server provides an option for the user to rate their contacts (e.g., friends and colleagues) according to how often the user would like to schedule an event with them. For example, a user may select: “never”, “rarely,” “often,” or “one event only”. This same methodology can be applied to groups. For example, a user may select to have events with his or her political group “rarely.” For interests, the user may be asked to rate the importance of these interests (e.g., political events=“once a quarter,” lunch events=“once every other week,” wine tasting events=“twice a week”). The user's ratings of contacts, groups, and interests are considered by the scoring process.

User travel preferences (418) (e.g., how far the user is willing to travel to meet with a contact for lunch). In some embodiments, the scheduling server 106 allows the user to specify preferences around how often the user is willing to travel. This embodiment asks the user to specify a radius that they are willing to travel various distances, although it would be readily apparent to one having ordinary skill in the art that other divisions of timing categories could also be used. For example, a user can indicate that they are “always willing to travel 1 mile”, “sometimes willing to travel 10 miles”, and “rarely willing to go as far as 25 miles”. The scheduling server then takes these considerations into account so that a user does not need to travel farther than 10 miles for more than 20% of their events. The defaults for these distances can change depending on the user's location so that New York uses a much smaller radius for each category, while Phoenix uses a larger radius for each category. For some alternate embodiments, the scheduling server may obtain these preferences through other means, such as asking whether the user has a car or other method of transportation at a particular time of day (e.g., lunchtime). The user's travel preferences are considered by the scoring process.

It should be understood that any information that would be useful for scheduling an event may also be included here, such as user dietary restrictions or dietary preferences, etc.

In accordance with some embodiments, the event preference information also includes event preference information received (420) from a second user and one or more additional users. It should be understood that the event preference information associated with the second user, or any other user, may be of the types previously described, and may be received by the scheduling server 106 by any of the previously described methods. In some embodiments, the second user is a contact of the first user and the event preference information includes a rating of the second user by the first user (e.g., Mike is a contact of John, Mike has rated John and John has rated Mike). In some embodiments, when two or more of the participants or users for a proposed event each have associated event preference information, the event preference information for each of the participants is used to determine the details of the proposed event. For example, if the first user likes restaurant A and restaurant B and does not like restaurant C, while the second user likes restaurant D and restaurant B, but does not like restaurant A, then a proposed event (e.g., a lunch) including both the first user and the second user will be scheduled at restaurant B, rather than restaurant A or restaurant D.

In some embodiments, the scheduling server is configured to schedule proposed group events (e.g., events including a plurality of participants from a predefined group of users). In accordance with some embodiments, the scheduling server 106 allows users to join or form event groups, either to facilitate small events among subsets of the users in the group, or to facilitate events for the group as a whole (e.g., all of the users in the group). In some embodiments the group owner specifies the ideal number of participants for an event; the ideal event frequency; whether concurrent events are permitted as might be needed for larger groups; whether the group moderator needs to be invited to all group events; if there are any specific geographic bounds for the group (e.g., that all events take place in Sunnyvale); whether there are any specific timing constraints (e.g., a specific day of the month that must be adhered to for events).

For example, a user might create local political event groups so that local members of a large political organization can get to know one another better in small working groups of 4-6 people. To continue the example, once per quarter, the scheduling server would arrange 20 concurrent events in and around Chicago for members of this political organization. To exemplify how a small event group might use the scheduling server, a group of 10 individuals might all be invited to a monthly event (e.g., lunch). However, because the scheduling server attempts to gather information on individual locations and availability, and measures individual response rates over time, the scheduling server is better able to propose the most convenient locations for those members who are likely to attend any particular meeting. The user's group affiliations are considered by the scoring process.

After receiving the event preference information (420) (e.g., in response to receiving the event preference information), in some embodiments, the scheduling server automatically, without human intervention, schedules (422) a first event for the user based at least in part on the gathered event preference information, wherein the first proposed event includes a first location, a first plurality of participants including the first user and a first contact of the one or more contacts of the first user, and a first date that was not selected by any of the first plurality of participants. It should be understood that, in accordance with some embodiments, an event time refers to a unique date and time combination (e.g., Wednesday, Apr. 15, 2009 at 12:30 pm PDT).

In accordance with some embodiments, scheduling a first proposed event based at least in part on the event preference information includes searching a database to determine previously defined event preference information including event preference information associated with the first user and, event preference information associated with the contact. For example, the time, location and participants included in the proposed event may be selected by the scheduling server based on the ratings of a first participant and a second participant for each other, the willingness of each participant to travel and the meeting location preferences of each participant.

### Scheduling Process

The process of automatically, without human intervention, scheduling events begins by looking at the availability of each user as indicated by the user's profile. In some embodiments this process starts (424) with the user who has the least availability. If there is no information on the availability of a user, then the user's availability may be set to a predetermined default value (e.g., “always available” or “once a week”). For that user, the scheduling server will review each of the user's contacts in descending order of the user-contact score.

In some embodiments, the scheduling server identifies (426) one or more contacts of the user with the highest user-contact score (e.g., the contact is the highest ranked contact, or the contact has a ranking of “schedule events frequently”) and selects a user-contact pair as participants in the proposed event. In some embodiments an event includes additional participants (i.e., a group event), as discussed in greater detail below. It should be understood that, in some embodiments, because the scheduling process is dependent on the scoring process, it must be run after the user-contact score pairs have been updated through the scoring process. It should also be noted that, by reviewing each of the user's contacts in descending order of the user-contact score, the best matches will be considered first. In some embodiments, the scheduling server will stop scheduling events for a user once it runs out of available dates within a predetermined timeframe (e.g., 28 days) or once it runs out of potential event participants (e.g., contacts of the user).

The scheduling server automatically identifies one or more dates for the proposed event. In some embodiments, the first step in this review is to identify a suitable date for the participants to meet for their event by identifying (428) a date with the highest score assigned to it through the scoring process. The scheduling server identifies a suitable date by checking to see if there is an available date within a predefined time period (e.g., 3-28 days from the current day) that is available for all of the participants. In some embodiments, after a tentative date is selected, the date scoring process is re-run to make sure that nothing changed which might cause the event to be cancelled, such as a user has changed their availability. Assuming the date score is positive (e.g., the date is available for all proposed participants), then, in some embodiments, the scheduling server sets a response deadline, such as three working days from the date that the meeting invitation is sent. If the score for a particular user-contact pair is zero, then the scheduling server will not schedule an event for that pair. For example, in accordance with this embodiment, if User A is only available for lunch on Tuesdays and User B is only available for lunch on Wednesdays, then User A and User B do not share any availability, and the user-contact pair score is zero, meaning that the scheduling server will not try to schedule a lunch between User A and User B.

In some embodiments, the scheduling server automatically selects (430) a location for the event. In accordance with some embodiments, the location selection process begins by identifying a general location for the event (also called an epicenter) using the location of each of the participants and the willingness to travel. For example if user A is located 10 miles from user B, and user A is willing to travel 8 miles, while user B is only willing to travel 3 miles, the scheduling server will identify an “epicenter” for the event that is 2-3 miles away from user B and 7-8 miles away from user A. For example, in one embodiment, when the participants' travel preferences are the same, the epicenter is a midpoint for participants who are more than 20 miles apart. In some embodiments, when the distance between the location of two users is less than a predetermined distance (e.g., 20 miles), the scheduling server selects one user's location as the epicenter, which effectively reduces the travel distance for the user who has their location selected as the epicenter.

In some embodiments, the scheduling server changes which user is benefited by the location of the epicenter based on the amount of traveling of the user to other events. For example, for a particular user-contact pair, the scheduling server may alternate which user travels farther by using the location of the user as the epicenter for even numbered meetings and the location of the contact for odd numbered meetings. In some embodiments, the scheduling server looks at the total distance traveled by the user in a given time period for events arranged by the scheduling server. As one example, a user has traveled a total of 50 miles for 4 events in the last month, a contact of the user has traveled a total of 5 miles for 4 meetings in the last month. In this example, the scheduling server will use the location of the user as the epicenter rather than the location of the contact, because the user has traveled greater distance recently.

After determining the epicenter, the scheduling server looks for event locations (e.g., a restaurant for a lunch event) within a given radius of the epicenter. In some embodiments, the type of event location (e.g., restaurant, coffee shop, state park, bar, etc.) selected by the scheduling server depends on the type of event. For example, a lunch meeting would be scheduled at a restaurant, while a pet-walking date would be scheduled at a dog park, and an after-work event would be scheduled at a bar.

In some embodiments, a travel radius is determined by looking at the travel preferences of the participant closest to the epicenter, or by using a ratio of the distance to the midpoint among the participants. In some embodiments, selection of an event location relies at least in part on users' declared preferences for different locations, considering factors such as how often the user has been scheduled for an event (e.g., a lunch) at a given location (e.g., a restaurant), how strongly the user prefers a given location, what the compatibility is between the respective participants' preferences for locations, how far the location is from the intended epicenter, and the like. In some embodiments, if the search for locations is unable to find a suitable location for the event from among the users' preferences, it will turn to event location rating service such as YELP or GOOGLE LOCAL, such as by using the Application Programming Interfaces (APIs) supplied by those services. It should be understood that if the scheduling server does not have location preference information for one or more of the users, then the scheduling server can select a location based on criteria that are not specific to any of the users (e.g., the rating of a restaurants within a predefined radius).

Additionally, in some embodiments, the scheduling server sets (432) a response deadline. In some embodiments the response deadline is a standard response deadline (e.g., 24 hours before the proposed event). In some embodiments, the response deadline is specified by event preference information provided by one of the participants (e.g., a user specifies that for all events where he is a participant he wants confirmation of the event one week in advance).

The scheduling server sends (434) an electronic message (e.g., email or SMS) to the first plurality of participants including an invitation to the proposed event. In some embodiments, once the scheduling server has determined who the participants are for an event, where the proposed event will take place, and when it will be, it sends an event invitation to the users. In some embodiments, this invitation and all subsequent updates to the invitation use a multipart email format which includes a text part, an HTML part, and a vcal or ical attachment. The vcal or ical attachment allows calendaring and email software such as OUTLOOK or GMAIL and GOOGLE CALENDAR to automatically insert the meeting invitation into the participant's calendar.

In accordance with some embodiments, for users who have previously received placeholders to reserve dates on their calendar, the meeting invitation is sent as an update to the placeholder instead of as a new invitation. This prevents confusion resulting from having both a placeholder and a meeting on the user's calendar at the same time. In some embodiments, the meeting invitations clearly indicate the response deadline, and ask users to click a link so that they can accept, decline, or update the meeting. In some embodiments, the scheduling server will also recognize the vcal and ical responses for accept, decline, tentative, and propose new time. Finally, in embodiments where information is available, the meeting invitation will provide the mobile phone and other contact details of the attendees so that users can contact one another should issues arise. In alternative embodiments, the meeting invitation may be relayed and presented to the user through other means, such as a text message, an instant messenger service, a social network's messaging capability like FACEBOOK, or through a custom client application (e.g., an IPHONE application, ANDROID application, or PALM application).

In accordance with some embodiments, the electronic message is sent by the scheduling server to a first participant of the plurality of participants includes an indication of a first travel time of the first participant to the first location; and the electronic message sent to a second participant of the plurality of participants includes an indication of a second travel time of the second participant to the first location. For example, for an electronic message (e.g., invitation) sent to a first participant by the scheduling server determines an approximate first travel time from the location of the first participant to the location of the event, while an electronic message sent to a second participant by the scheduling server includes a second travel time from the location of the second participant to the location of the event. In some embodiments the first and second travel times are determined by sending a query to an external travel time calculation program such as a web-based mapping program (e.g., GOOGLE MAPS or MAPQUEST). In some embodiments the first and second travel times are determined using a proprietary travel time prediction algorithm.

In some embodiments the provided travel time takes into account the time of day, day of week, likely traffic conditions at the time of the meeting, etc. In some embodiments this travel time is included in the invitation (e.g., “travel time to your event location is 15 minutes”). In some embodiments, driving directions are included along with the travel time. In some embodiments a map is included in the invitation. In some embodiments, at least one of the start time or the end time of the event is adjusted for one or more of the plurality of participants based on the predicted travel time for the respective participant to the event location. In embodiments where the electronic message includes an automatic calendaring part (e.g., a vcal or ical attachment) the automatic calendaring part includes start and end times adjusted based on the travel time. For example, when Participant A and Participant B are participants in an event that is lunch at a restaurant that is located 15 minutes from Participant A and 9 minutes from Participant B. In this example, the service schedules Participant A from 11:45 am to 1:15 pm, and Participant B from 11:51 am to 1:09 pm. It should be understood that, because the travel time is calculated as a function of the distance that a respective participant needs to travel to the location of the event, in accordance with this embodiment, the start time and end time of the event may be different for each user.

In some embodiments, the electronic messages include an option for a participant to invite one or more contacts to join the event.

In some embodiments a plurality of events are automatically scheduled by the scheduling server. In particular, in response to receiving (402) the event preference information from the first user, and optionally receiving (420) event preference information from a second user, the scheduling server automatically, without human intervention, schedules (436) a second proposed event based on the event preference information. In some embodiments, the second proposed event includes at least a second location, a second plurality of participants that are distinct from the first location and the first plurality of participants. In some embodiments, the second plurality of participants includes at least one participant that is not included in the first plurality of participants. In some embodiments, the second event includes the first user and a second contact of the one or more contacts, and a second date that was not selected by any of the second plurality of participants, wherein the second proposed event is not a recurrence of the first proposed event. As used herein, a recurrence of an event is an event with the same participants that occurs at regular intervals (e.g., on the same day(s) of the week for a plurality of weeks or the same day(s) of the month for a plurality of months) for substantially the same purpose. Thus, to say that the second event is not a recurrence of the first event means that the second event includes one or more of: one participant not included in the first event, a different location, occurs on a different day of the week, time of day, day of the month, or is for a different purpose. For example, having lunch with Participant A at Restaurant X instead of socializing with Participant B at Restaurant Y are not recurrences of an event even if they occur at the same time (e.g., 12:30 pm) on the same day of the week (e.g., the first Wednesday and the second Wednesday in April, respectively) or day of the month (e.g., the 15th of April and the 15th of May, respectively).

After determining the relevant details for the event, as discussed above in greater detail with reference to scheduling a first event, the scheduling server sends (438) an electronic message to the second plurality of participants, including an invitation to the second proposed event. It should be understood that in addition to scheduling a first event and a second event one or more additional events may be automatically, without human intervention, scheduled by the scheduling server using the process described above, wherein at least a subset of the one or more additional events does not include a recurrence of any of the previous events. For example, User A provides event preference information into the scheduling server including contact information for three friends and two co-workers. The scheduling server schedules User A for five lunches over the course of the subsequent month, where each lunch is with a respective friend or co-worker, and the lunches are scheduled in accordance with the availability of User A and the friends and co-workers of User A.

After invitations to the proposed event have been sent out, the scheduling server waits to receive replies from the invited participants. In some embodiments, the scheduling server receives a reply from at least a one of the participants that is an acceptance of the event (e.g., “I will attend the event”). If the reply is (450) an acceptance then the scheduling server checks to see whether it has received a sufficient number of acceptances to confirm the meeting. If the scheduling server has (452) received a predefined threshold (e.g., a sufficient number or sufficient percentage) of acceptances to confirm the meeting, then in some embodiments the scheduling server sends (454) an electronic message (e.g., an email or SMS) to each of the plurality of participants including a confirmation of the first proposed event. In some embodiments the predefined threshold is an acceptance from at least one participant other than the first user. In some embodiments, the predefined threshold is an acceptance from at least half of the participants. In some embodiments, when scheduling an event with more than two participants, the predefined threshold is that more than two acceptances must be received. In some embodiments this threshold is part of the event preference information specified by the user.

It should be understood that there are many different possible embodiments for receiving an acceptance from a participant, including without limitation: an email with a vcal or ical response, a selection on an interactive website, a social networking website application (e.g., a FACEBOOK application), a mobile device application (e.g., an IPHONE application), an instant messaging service, a text message, or any other reply means known to one skilled in the art. In accordance with some embodiments, if the user includes any notes (e.g., “look forward to having lunch with you”) with his or her acceptance, then these notes are added to the meeting notes for the invitation and included in all messages sent to event participants regarding this event.

In some embodiments, participants are permitted to provide tentative responses (e.g., “maybe”). If the scheduling server receives a tentative response from a participant through any of the channels described above, the participant's response is set to tentative, and, if this is different than the user's previous response, a revised event invitation is sent to the participant. If the user includes a note with their response, then revised meeting invitations may be re-sent to all members with the note included.

In some embodiments, a confirmation (e.g., an email stating that the event has been confirmed) is sent to each participant along with an updated event invitation one week prior to the event. In some embodiments a confirmation is one or more of the following: an email, a text message, proprietary social network message, instant messenger message, and/or a notification sent through a custom client application (e.g., an IPHONE application). It should be understood that different participants for the same meeting may each receive a confirmation for the same meeting using a different type of confirmation message (e.g., a first participant receives a confirmation email and a second participant receives a text message). It should also be understood that a single participant could receive multiple confirmations for the same meeting using a plurality of the types of confirmation messages (e.g., a first participant receives both a confirmation email and a confirmation text message for the same event). In some embodiments, a confirmation is only sent to the participants who have accepted the event. In some embodiments, a confirmation is only sent to the participants who have accepted or tentatively accepted the event. In some embodiments the confirmation is sent to all of the participants who have not declined the event.

In some embodiments, sending an electronic message to the plurality of participants includes booking (455) a reservation for the event at the first location. For example, when the event is for User A and User B to have lunch at Restaurant X for 12:30 pm on Apr. 15, 2009, the scheduling server makes a reservation at Restaurant X at the specified time. In some embodiments booking a reservation includes contacting the event location directly with the event information (e.g., sending an email to Restaurant X). In some embodiments booking a reservation includes using a third party reservation application (e.g., OPEN TABLE) to create a reservation using the event information.

In some embodiments, if the scheduling server has not (456) received sufficient acceptances to confirm the event, or the reply received by the scheduling server was not (458) an acceptance, then the scheduling server does not send a confirmation to the participants.

In some embodiments, if the reply indicates (460) an updated location, date or time, the scheduling server resets (462) the response status (e.g., “accept,” “reject,” “tentative” or “no reply” are all reset to “no reply”) for all participants other than the participant who sent the reply with the updated location, date or time, and resends the invitation to the other participants. For example, Users A and B have accepted an event when User C proposes a new time for the event, and the scheduling server changes the event to a new time and sends out a revised invitation indicating the new time. In this example, Users A and B have not confirmed that they can attend at the new time, and so their responses are reset to “no reply.”

In some embodiments, when the location, date and time are not (464) updated, the scheduling server checks to see if a note has been added by the reply. If a note is (466) added to the event by the reply, (e.g., “I'll bring a copy of my proposal to our lunch meeting”), then the scheduling server sends (468) an invitation to all participants, where the invitation includes the note, while preserving the response status for each of the participants. For example, if Users A and B have accepted an event, when User B sends a note for the event, the scheduling server sends an invitation to User A including the note, but does not reset the response status of User A, because the details (e.g., time, date, location) of the event have not changed.

In some embodiments, the reply received from the participant indicates (472) a rejection of the first proposed event. In some embodiments, the scheduling server marks (474) the rejecting participant as unavailable for the event time. For example if User A rejects (e.g., declines) an event at 12:30 pm on Apr. 15, 2009, it is likely that User A has a conflicting obligation and thus the scheduling server will avoid attempting to schedule any further events for that time by marking the participant as unavailable at that time. In some embodiments, a cancellation message is sent to the participant who rejected the event in addition to marking the participant as unavailable for that time.

In some embodiments other event preference information for the participant is also updated. For example, if the event was for a restaurant, and the participant has previously rejected an event at the same restaurant, the participant's event preference information may be changed to indicate that the user does not like that restaurant and thus will not automatically schedule other events at that location. It should be understood that other event preference information (e.g., user ratings, time of day preferences, willingness to travel) can be automatically determined in this manner. In some embodiments when a participant rejects an event, the participant is given a number of options for indicating why the event was rejected (e.g., “too early” “too late” “too long” “too far away” “I don't like the location,” etc.).

In some embodiments when sufficient (476) rejections (e.g., declines) have been received from a predefined threshold of the participants, the scheduling server sends an electronic message to a plurality of the participants including a cancellation of the first proposed event. In some embodiments the plurality of participants includes all participants for the event. In some embodiments, the plurality of participants includes only the participants for the event who have accepted the event. In some embodiments the plurality of participants includes all of the participants for the event who have not rejected the event.

In some embodiments the predefined threshold of rejections is reached if, as a result of the received rejection, there are not at least two participants who can confirm their attendance at the event. When the predefined threshold is reached, cancellations (e.g., electronic messages indicating that the event has been cancelled) are sent to all members who have not already received a cancellation. For example, if there are four participants invited to an event and one of the participants has accepted the event while one of the participants has rejected the event, the event is not cancelled until the other two participants reject the event. In some embodiments, the predefined threshold of attendees is greater than two, in which case, if there are fewer participants than the predefined threshold capable of accepting the event (e.g., if all attendees who have not rejected the event accepted it, the event would not meet the predefined threshold of participants), then the event is cancelled. In some embodiments, if the rejecting participant included a note with their rejection of the event, then this note is included in all invitations and cancellations associated with the event. In some embodiments the predefined threshold is a percentage of the invited participants (e.g., 25% or 50%) rather than a fixed number. In some embodiments this threshold is part of the event preference information specified by the user.

If the predefined threshold of rejections is (476) met, then a cancellation is sent (477) to a plurality of the participants. In some embodiments the plurality of participants is all of the participants, in some embodiments the plurality of participants is all participants who have not yet received cancellations. If there are not (478) sufficient rejections to cancel the event (e.g., the predefined rejection threshold has not been met), or if the reply is not (480) a rejection the scheduling server checks to see if the response deadline has been reached. If the response deadline has not (482) been reached, then the scheduling server waits for additional replies for the event or for the response deadline to be reached. In some embodiments the scheduling server periodically checks (e.g., twice a day) to determine if the response deadline for any of the events has been reached.

If the event deadline has (484) been reached, the scheduling server checks to determine whether there are enough acceptances to confirm the meeting. If replies indicating an acceptance of the event have not (486) been received from at least a predefined threshold of the participants (e.g., at least two or at least half of the invited participants) before a predefined time period has elapsed (e.g., twenty four hours before the start time of the event), the scheduling server sends (477) a cancellation. In some embodiments a cancellation of the event is an electronic message indicating that the event has been cancelled. In some embodiments sending the cancellation to a plurality of the participants includes sending the cancellation to all participants who have accepted the event. In some embodiments sending the cancellation to a plurality of the participants includes sending the cancellation to all participants who have not already received a cancellation for the event.

If the scheduling server determines that the response deadline has (484) been reached and the scheduling server also determines that the predefined threshold of acceptances has (488) been reached (e.g., at least two participants have accepted), then the scheduling server sends (454) a confirmation to all parties who have accepted, as discussed in greater detail above.

In some embodiments, the scheduling server periodically receives location information (e.g., global positioning service data or wireless signal triangulation data) from a client that is a mobile device. In some embodiments this location information is associated with a time that the location information was acquired. The scheduling server uses this time-specific location information to determine the likely location of the user at a particular time of day or day of the week. In some embodiments this likely location information is stored as event preference information for the user. For example a user has a cell phone with a global positioning service (GPS) location module or cell tower triangulation module; at 12:30 pm each day, an application on the cell phone associated with the scheduling server records the location from the GPS module. In this example, the cell phone periodically sends this information to the scheduling server and the scheduling server uses this information to identify the workplace of the user during the week and the event sever uses that location as the user's location for the purposes of selecting locations for the user's weekday events that occur around 12:30 pm (e.g., lunches with coworkers).

In accordance with some embodiments, reminders are sent as updated event invitations to each participant who has not responded at least twenty four hours before the response deadline for the event. In some embodiments the event preference information includes a parameter to adjust this reminder period. In some embodiments, the scheduling server uses a built-in alert function within a calendar event standard (e.g., the ical or vcal format) to embed reminders into the event invitations. In accordance with this embodiment, the electronic calendars of the participant will display a reminder to the user at one or more predetermined times before the event. In some embodiments, the predetermined time is a default predetermined time of a calendar application such as OUTLOOK or an online calendar application, such as GOOGLE CALENDAR or YAHOO CALENDAR. In some embodiments the user sets a custom predetermined time. It should be understood that reminders may also be sent through other channels including text messages, social networks, instant messengers, and custom client applications like (e.g., IPHONE applications).

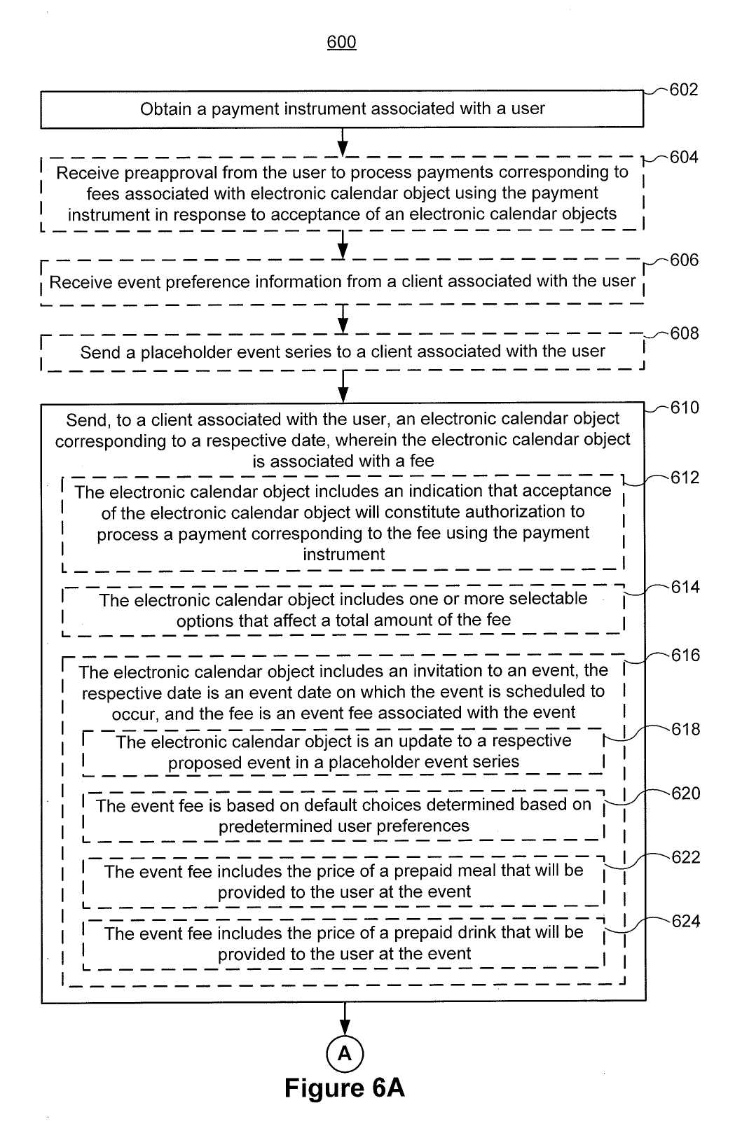

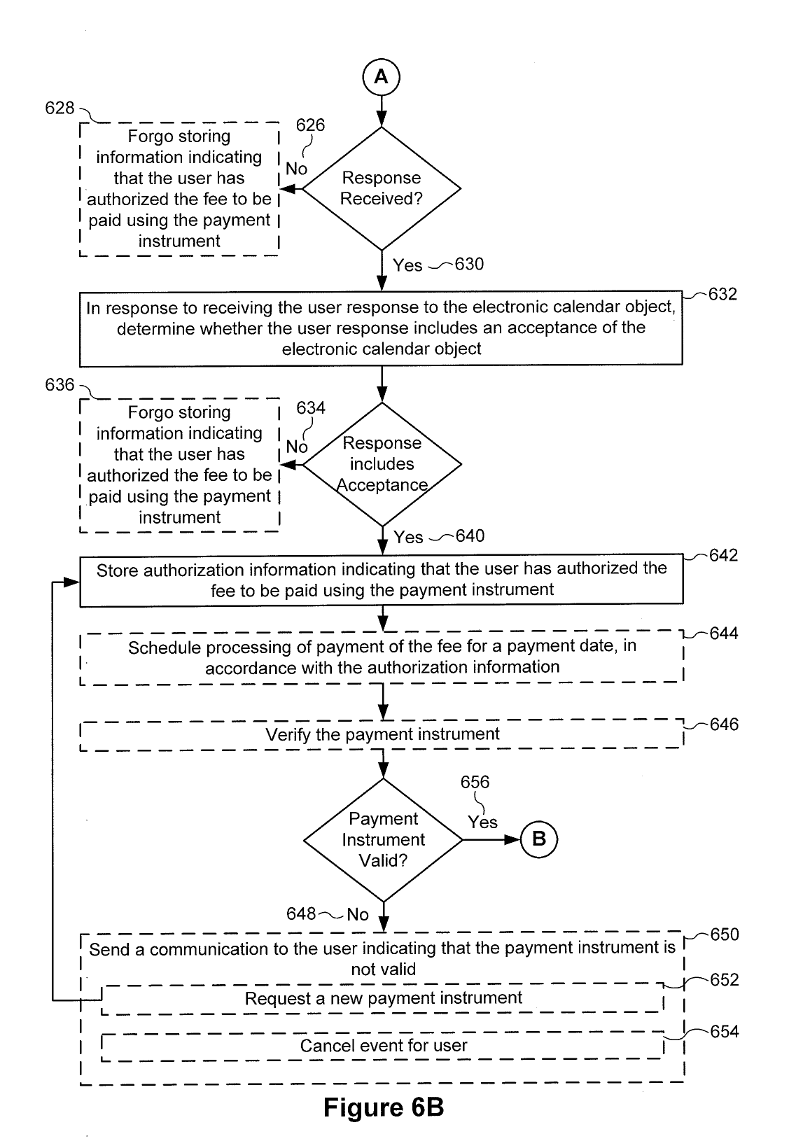

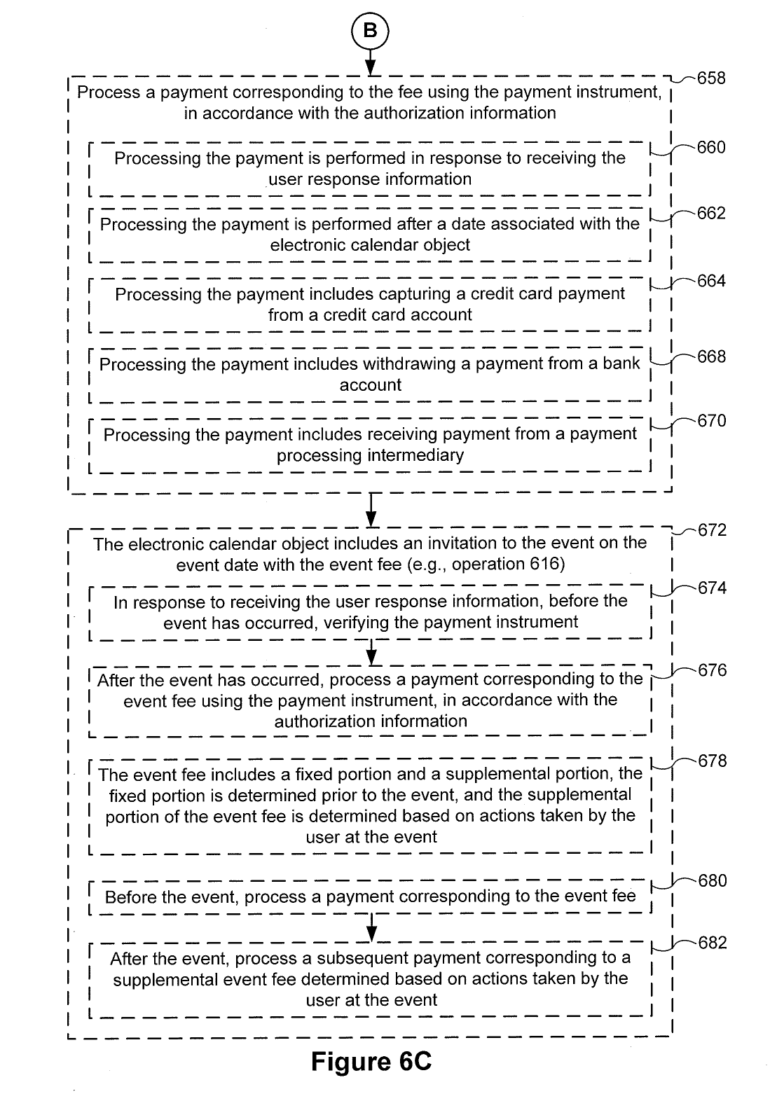

It should be understood that the particular order in which the operations in FIGS. 4A-4B have been described are merely exemplary and are not intended to indicate that the described order is the only order in which the operations could be performed. One of ordinary skill in the art would recognize various ways to reorder the operations described herein. Additionally, it should be noted that details of other processes described herein with respect to method 600 (described herein with reference to FIGS. 6A-6C) are also applicable in an analogous manner to method 400 described above with respect to FIGS. 4A-4B. For example, the events, invitations and payments described above with reference to method 400 optionally have one or more of the characteristics of the various events, invitations and payments described herein with reference to method 600. For brevity, these details are not repeated here.

### Event Scheduling User Interfaces

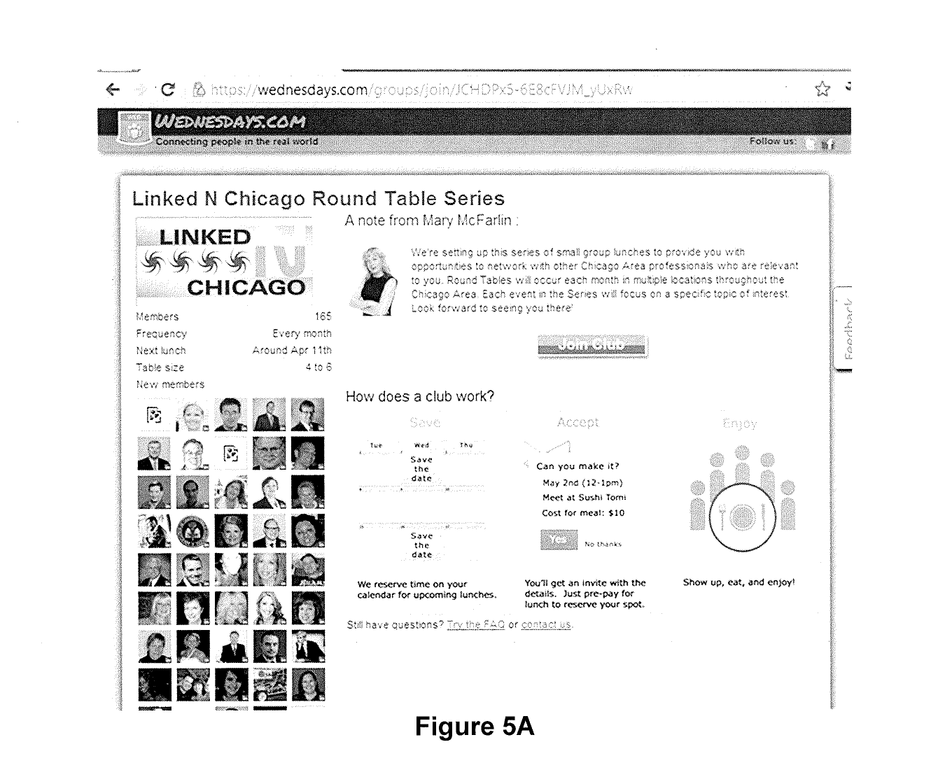

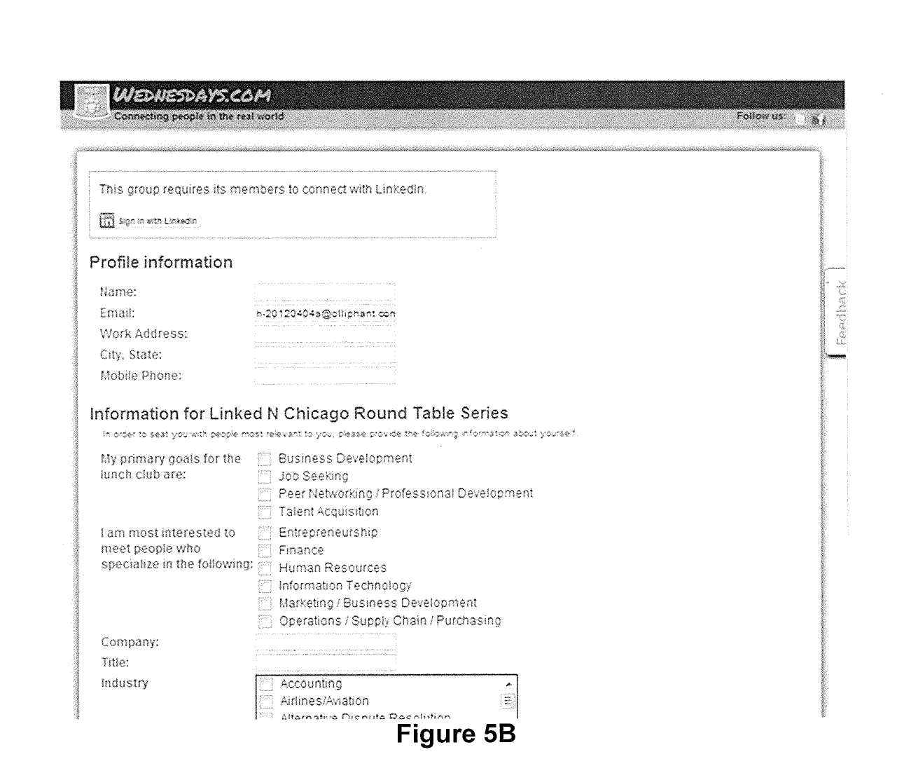

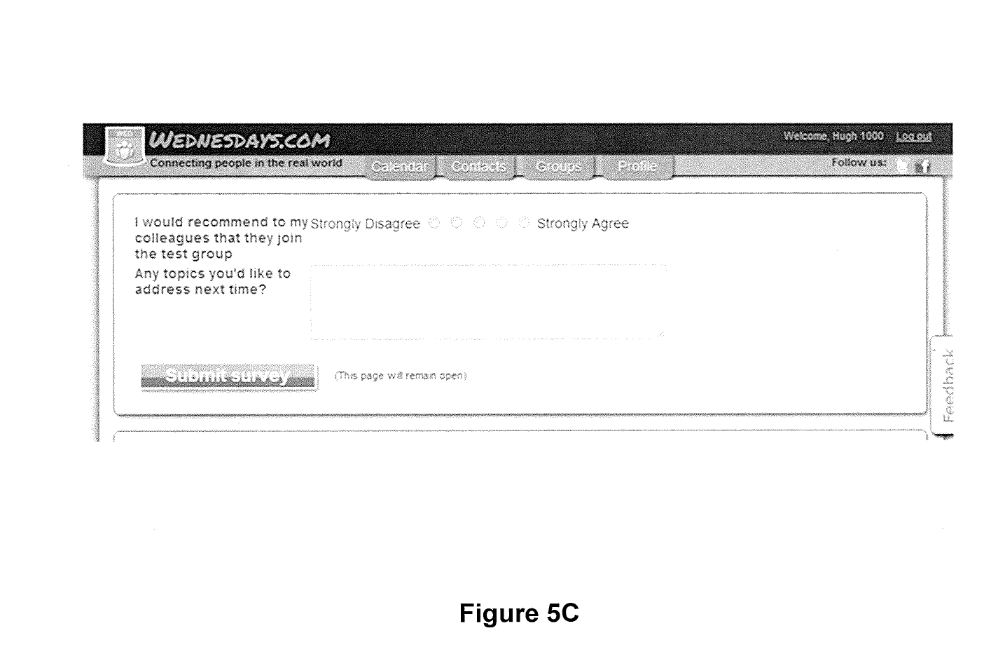

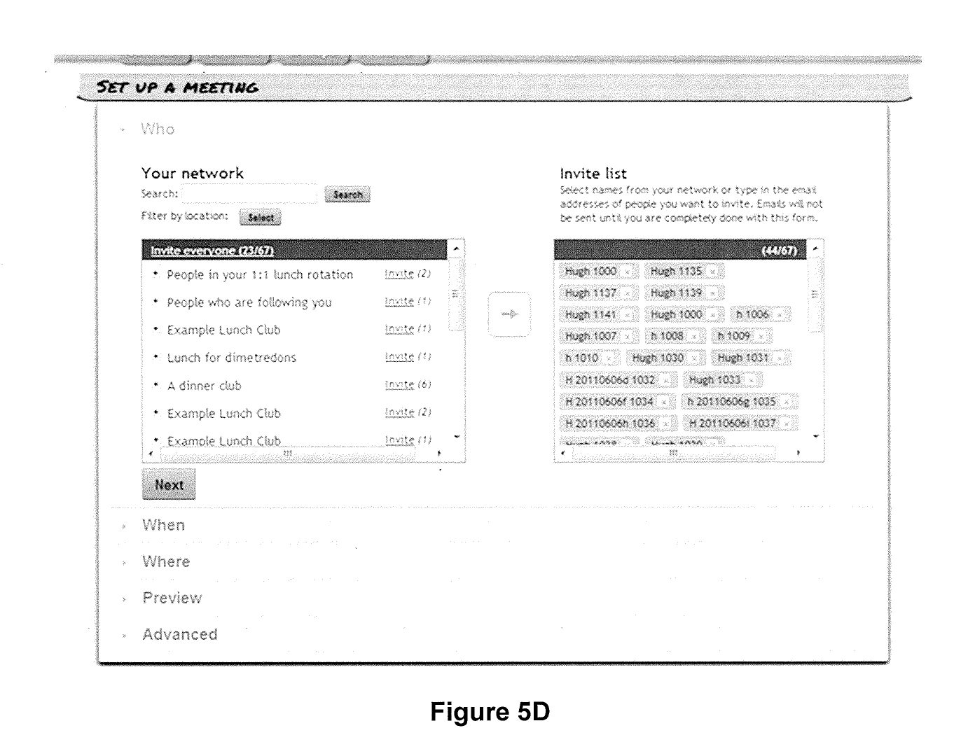

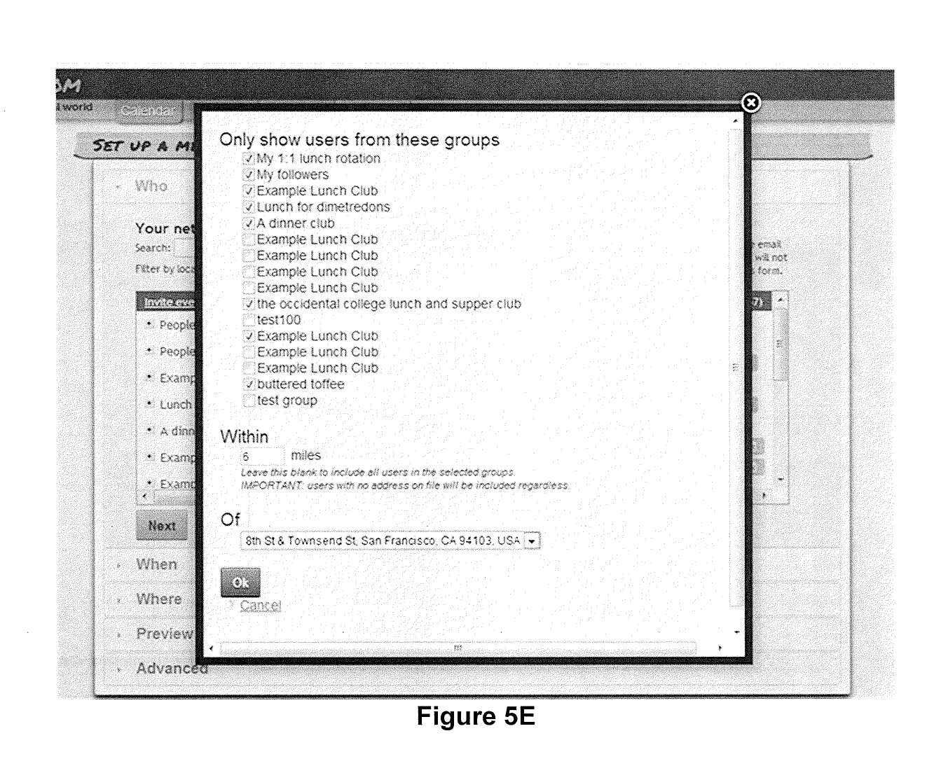

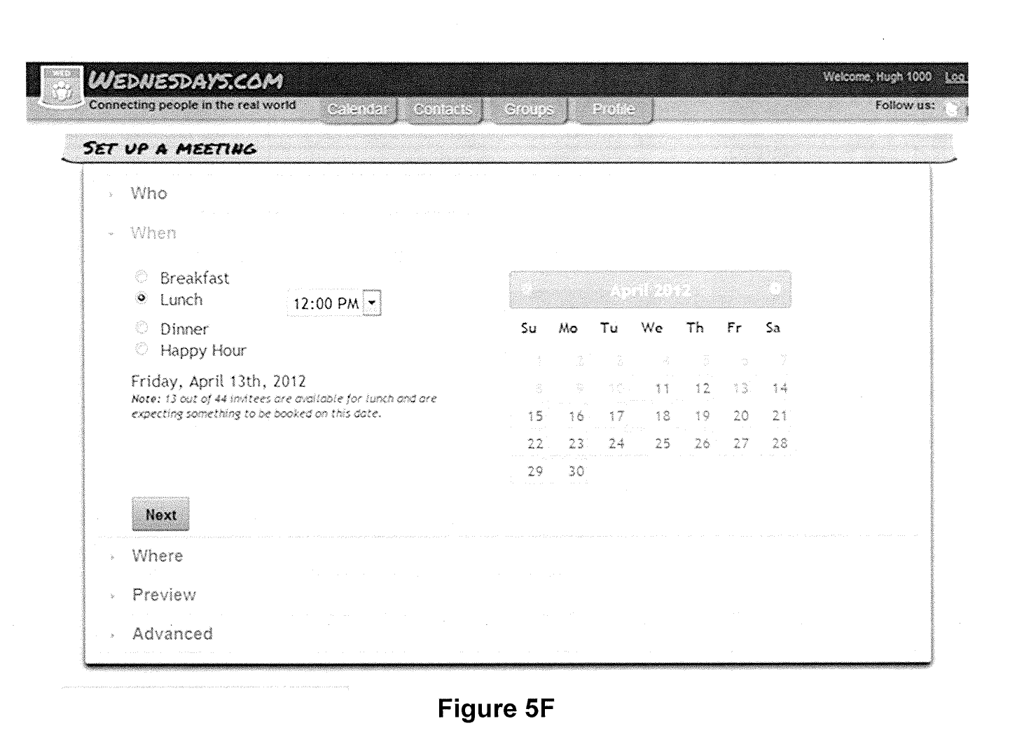

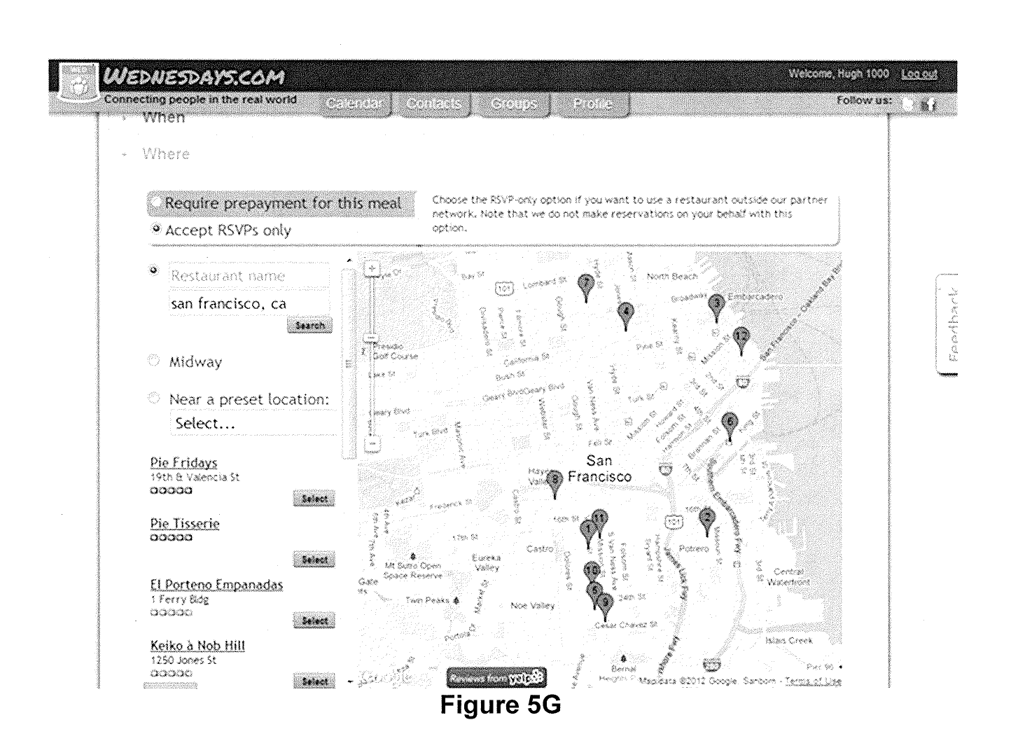

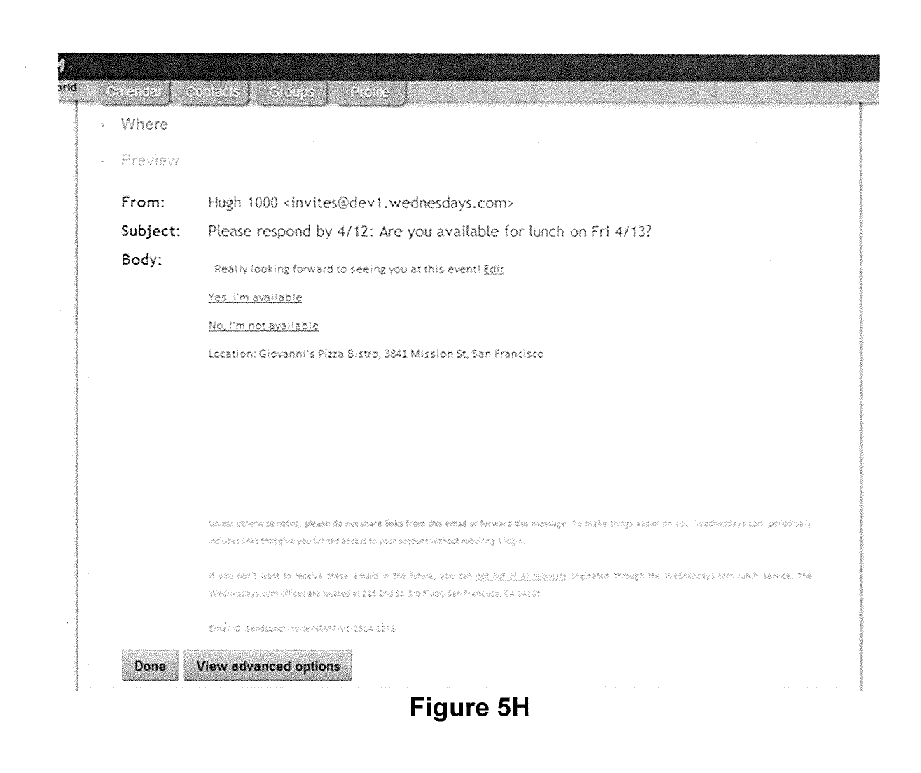

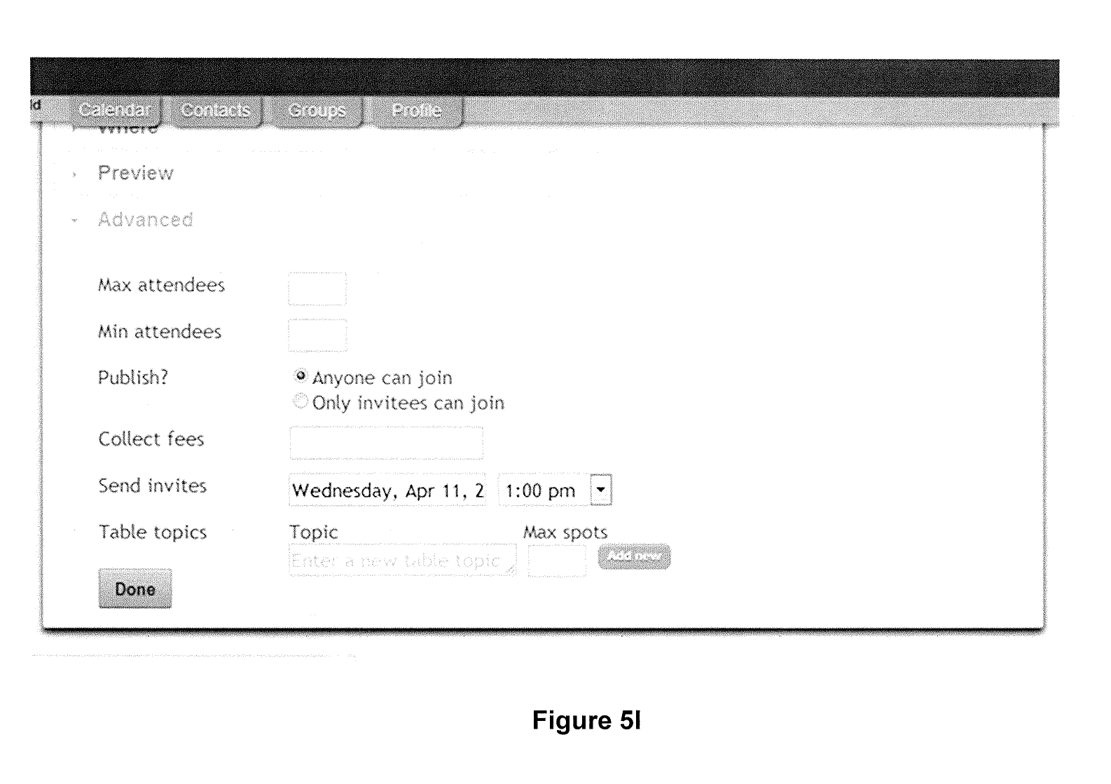

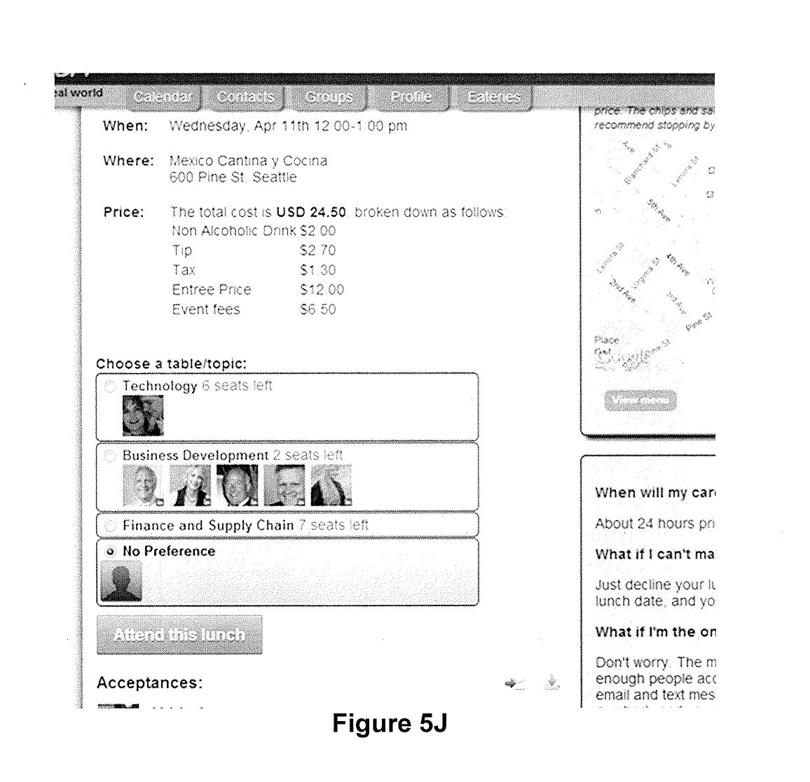

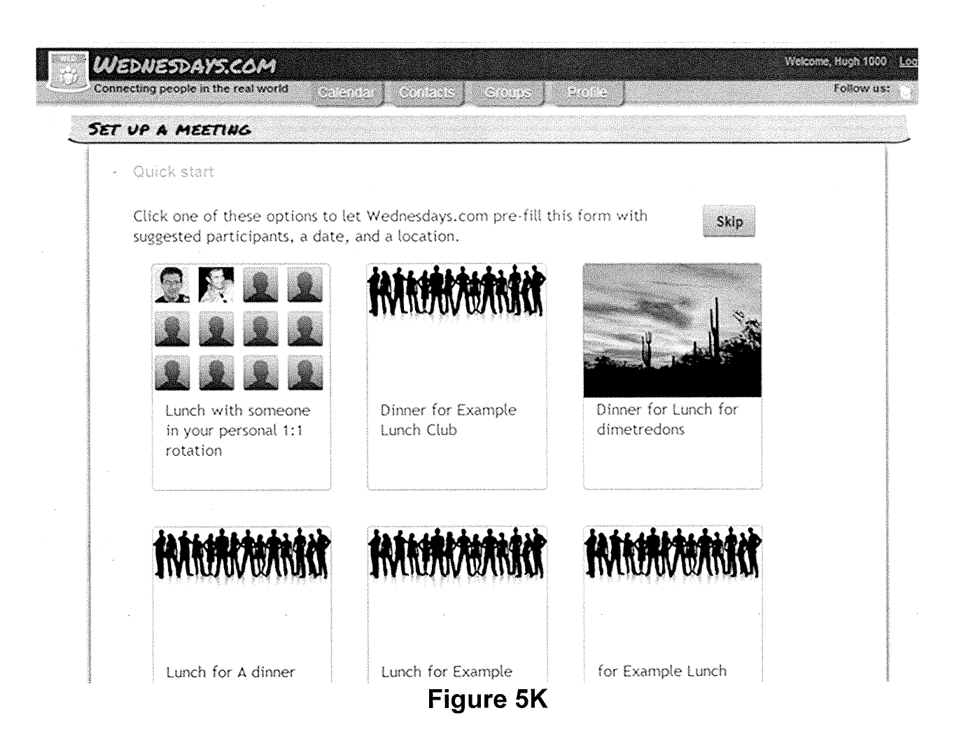

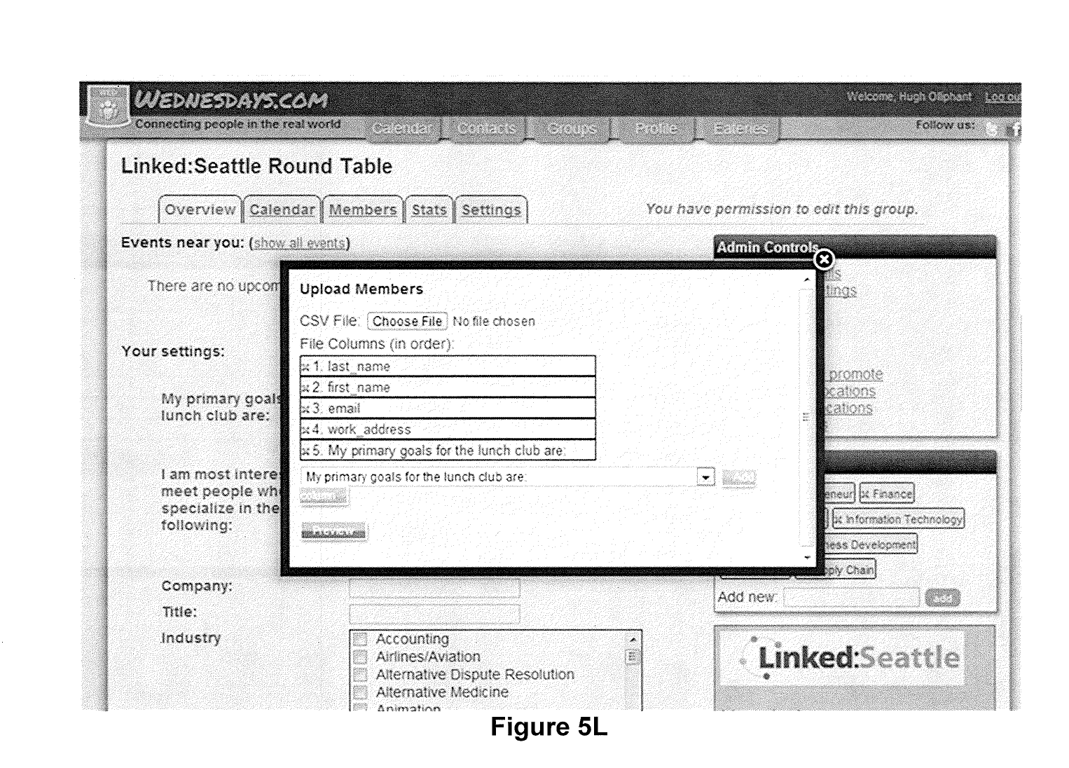

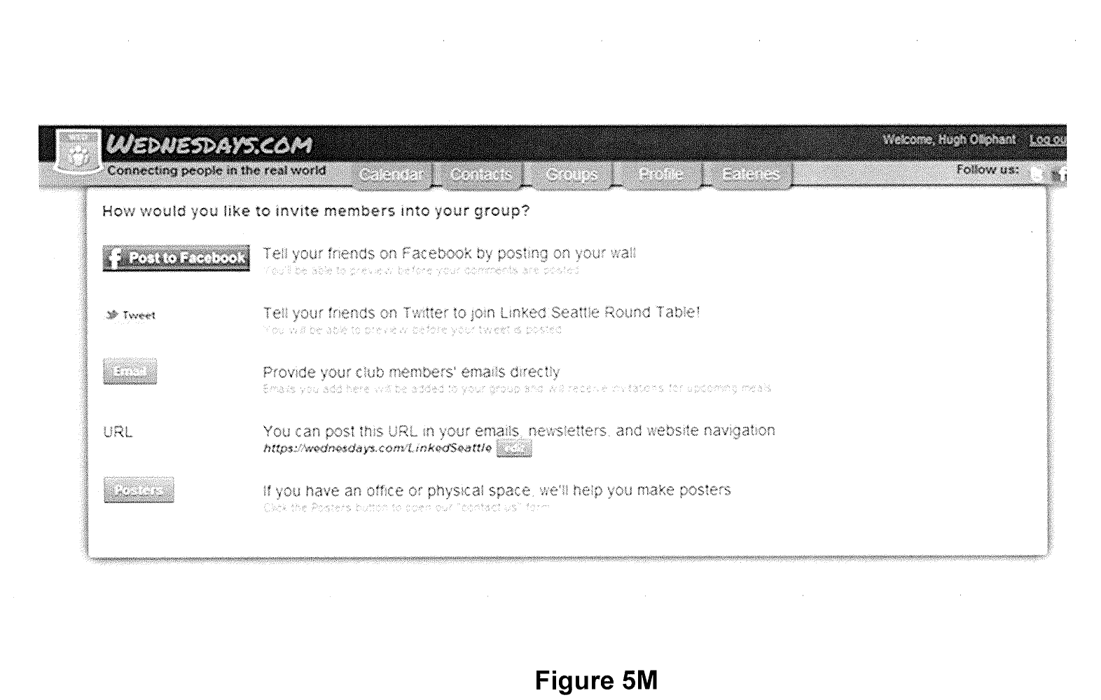

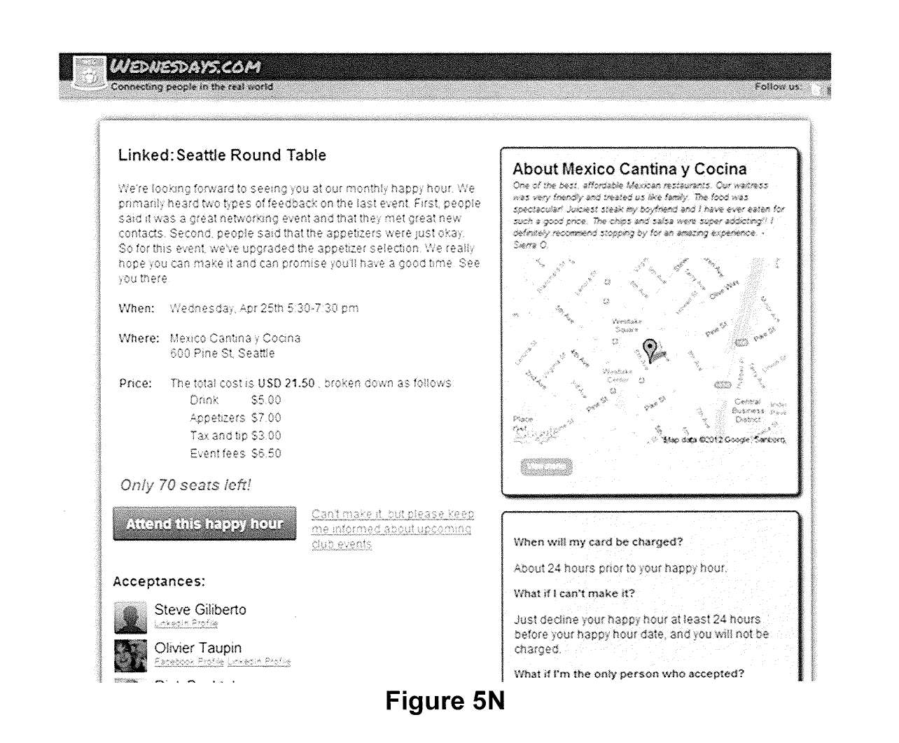

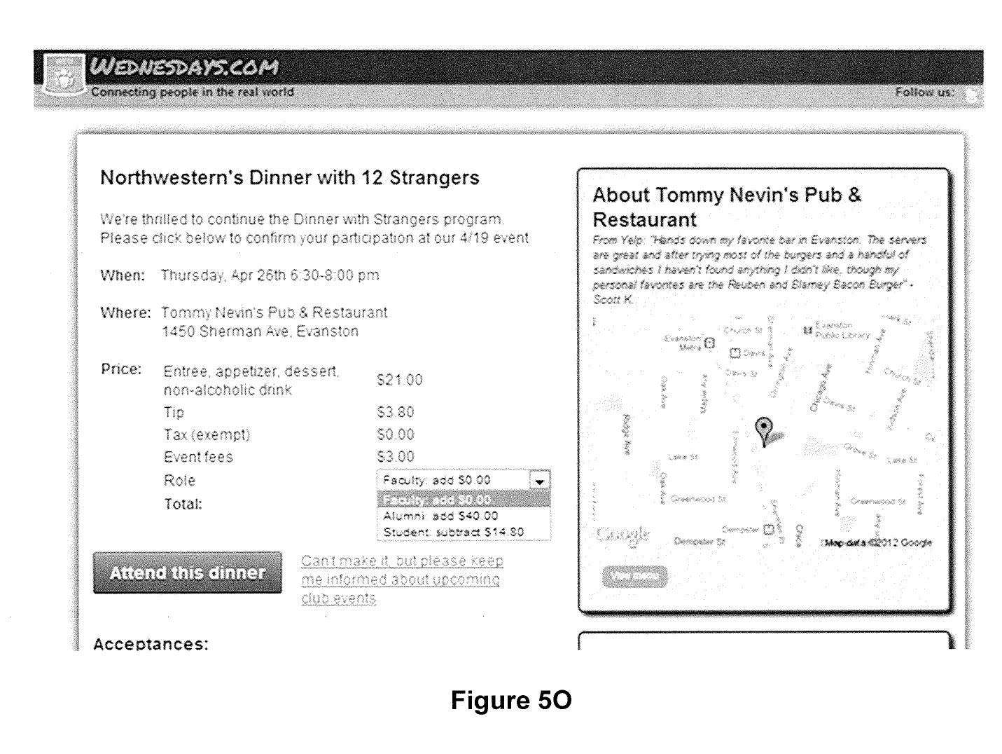

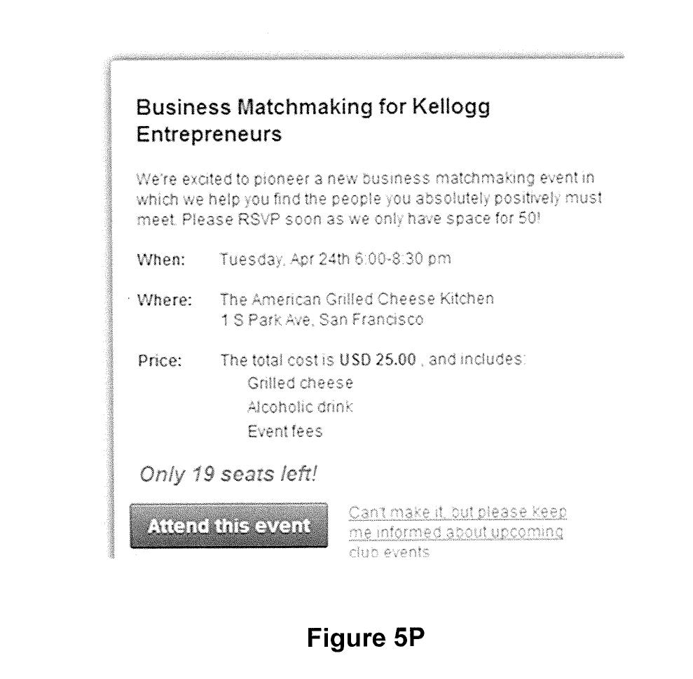

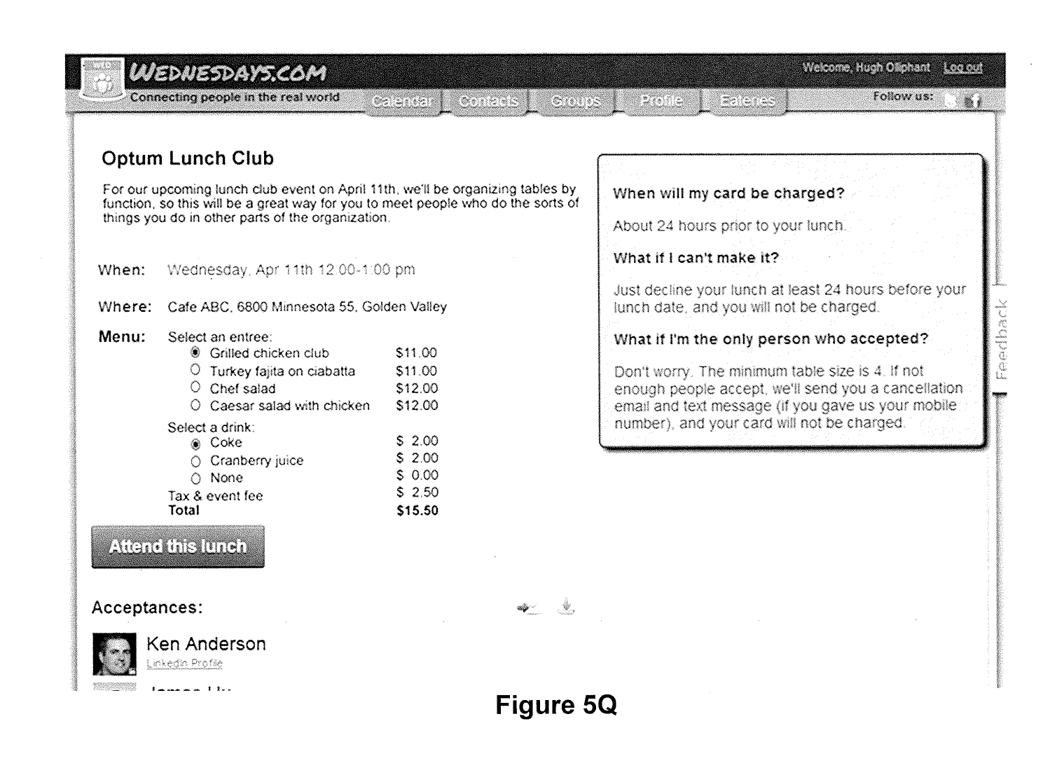

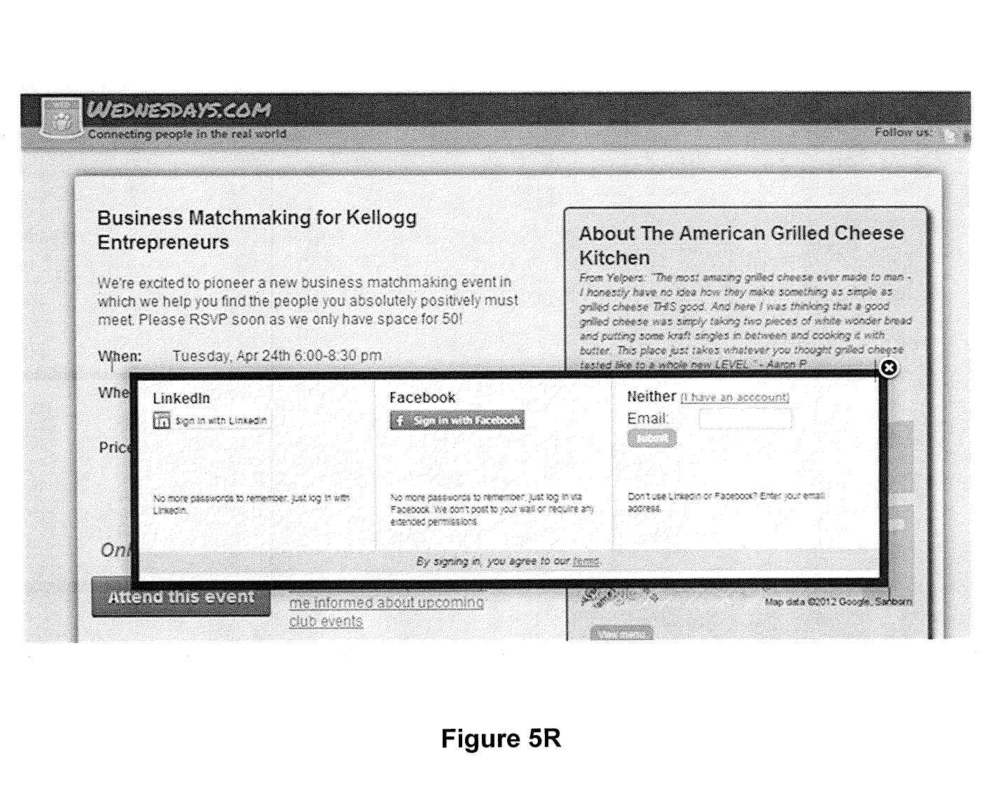

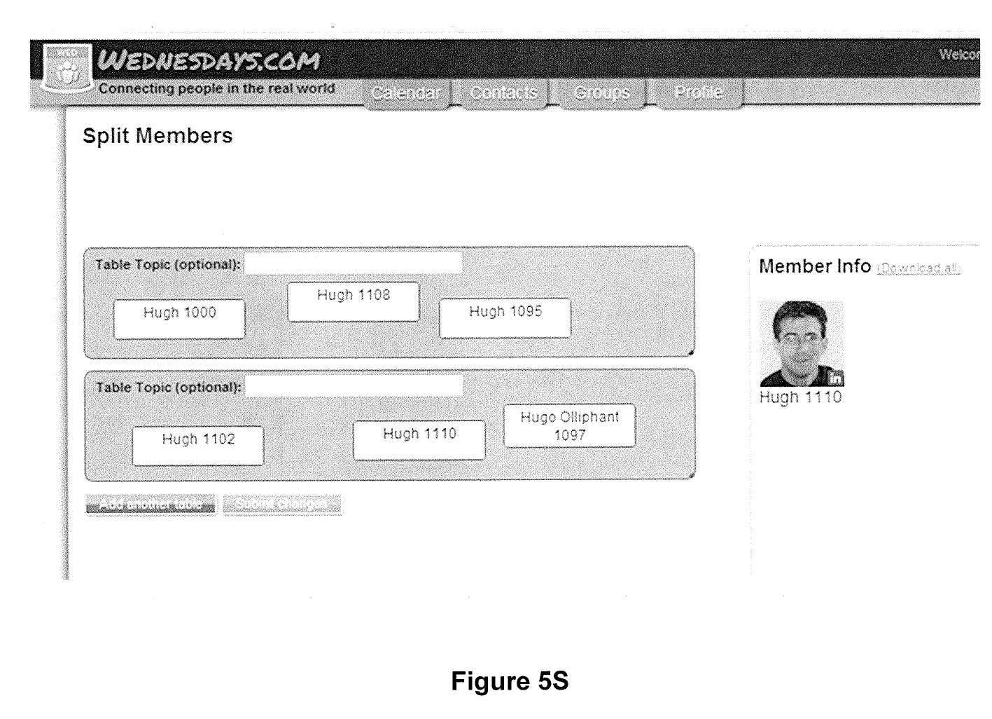

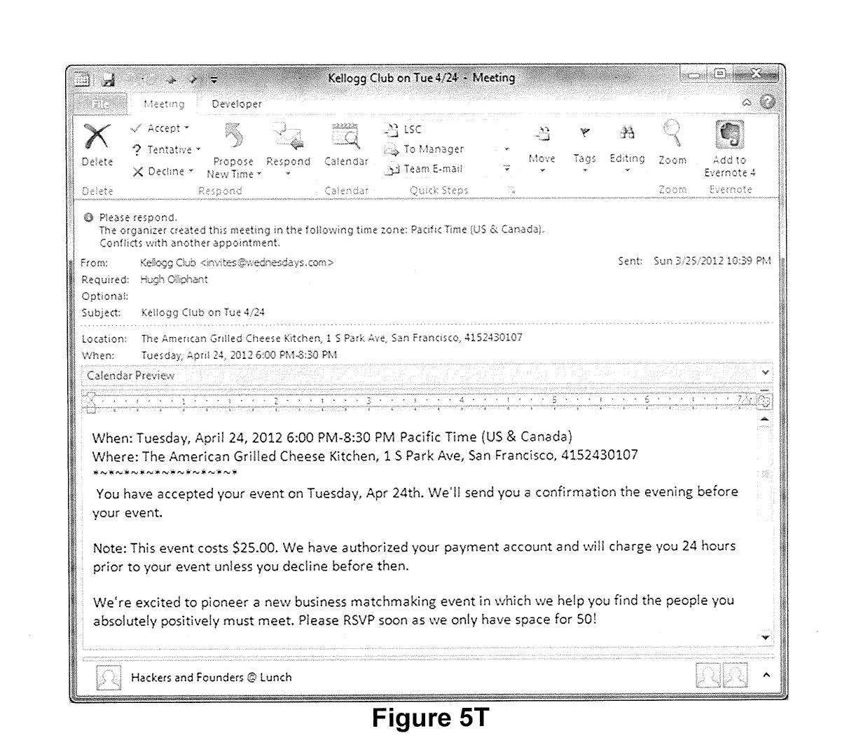

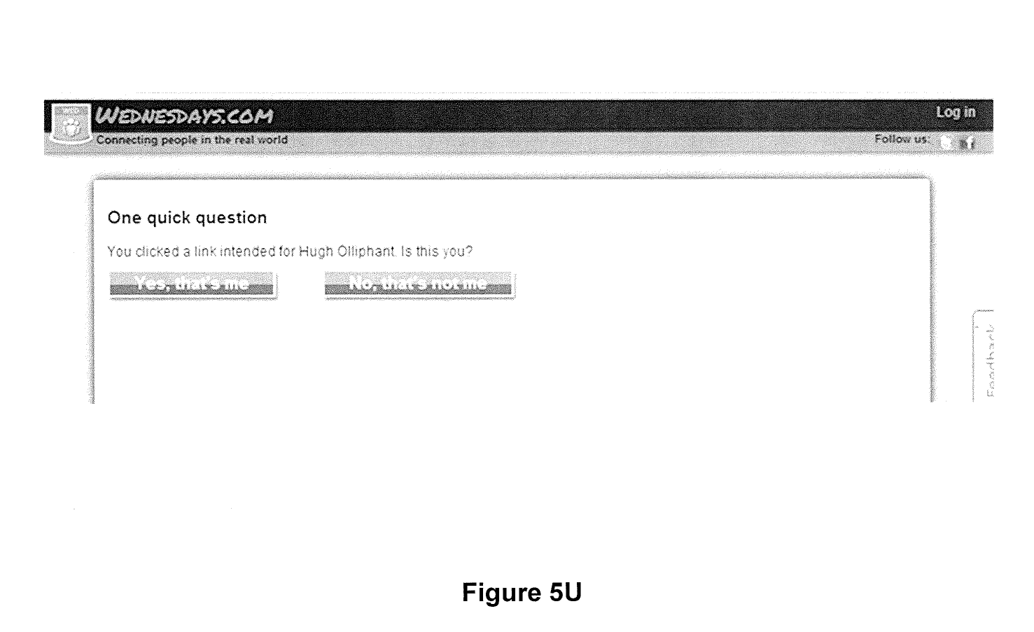

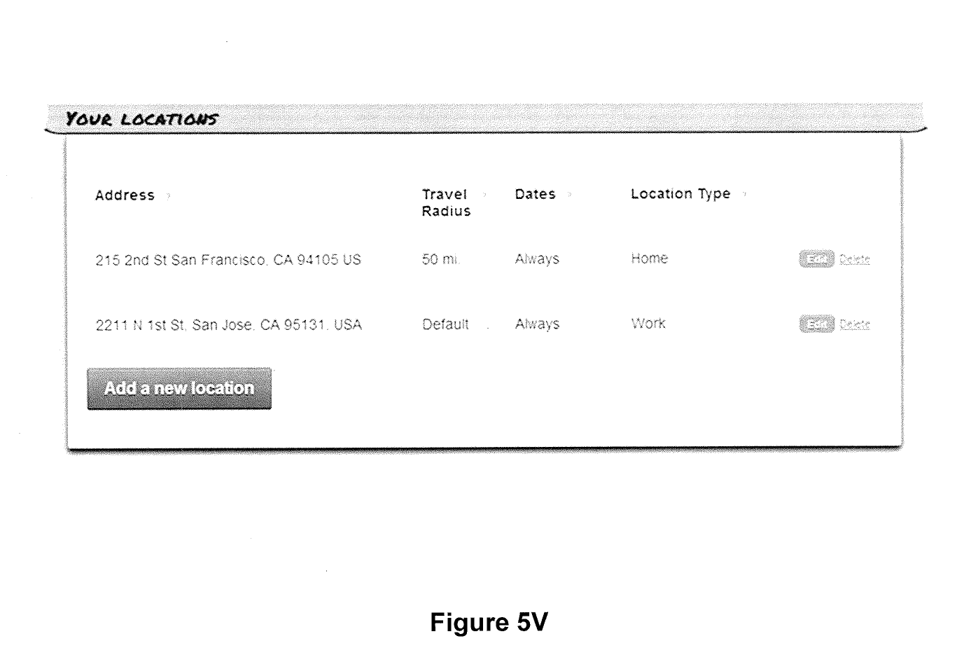

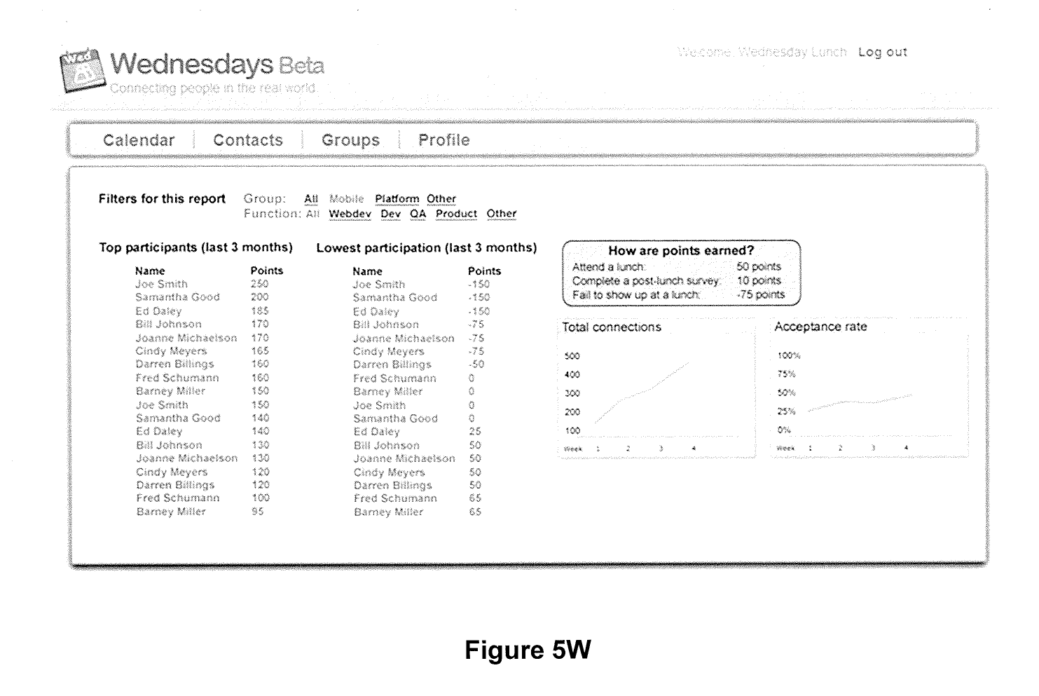

Attention is now directed to FIGS. 5A-5W, which illustrate example user interfaces for event scheduling, in accordance with some embodiments.

An organizer can get started in one of two ways: (1) Create a group: The organizer can provide preference information around his or her group and allow the scheduling server 106 to generate events automatically; and (2) Create an event: The organizer can create an individual event with the option of building a group around that event and/or automating future events.

### Creating a Group

This section describes an example of the process of creating a group which involves collecting a number of pieces of information:

(1) Basic group information: In some embodiments, the organizer provides basic information, such as the name of the group, and introductory text to describe the purpose of the group and/or its events. Other information optionally includes the name and picture of the group's organizer(s). FIG. 5A shows an example of displaying basic information to members as they join. In some implementations the organizer provides this information to the scheduling server 106, and the scheduling server displays this information accordingly.

(2) Event preference information: In some embodiments, the organizer provides details around the type of events the organizer would like to automate (e.g., lunch, dinner; breakfast, or happy hours), how often the organizer would like the events to take place (e.g., the 2nd Wednesday of each month), the time of day (e.g., noon) for these events, the types of venues the organizer prefers, the price range the organizer would like. In some implementations the organizer provides this information to the scheduling server 106, and the scheduling server schedules events accordingly.

(3) Payments information: In some embodiments, the organizer is able to add a fee for his events. The organizer is provided with the option to provide information around how much he wants to collect per person, whether he wants to offer any discounts against those fees (e.g., the first four people to RSVP receive a discount, or participants X and Y will have their meal paid for). If necessary, the organizer can provide this information across multiple currencies. Additionally, the organizer optionally provides instructions around how the scheduling server 106 can remit the organizers' fees to himself or to his organization. This can include PayPal account information, bank account information, and any necessary tax compliance information. In some embodiments, the organizer can charge a subscription fee to users who want to be invited to or participate in his group's events. In some embodiments, the organizer is provided with the option to define price differentials for different subsets of members, such as a higher price for non-members. For an example, as illustrated in FIG. 5O a price differential optionally includes charging less to students and faculty than is charged to alumni or a school. In some implementations the organizer provides this information to the scheduling server 106, and the scheduling server 106 provides pricing options to invitees accordingly.

(4) Member questionnaire information: The organizer can specify information to be collected from users when they either join the group or join a meal hosted by the group. An example of the types of questions an organizer might pose is shown in FIG. 5B. The information gleaned from this survey can later be used for event logistics (e.g., deciding who will sit next to whom at a particular table). In some embodiments, the organizer specifies the answers to one or more of these questions as introductory blurbs that allow members to learn a little bit about one another through things like event confirmation emails or table tents printed out and placed on tables for meals. In some implementations the organizer provides this information to the scheduling server 106, and the scheduling server 106 generates emails or table tents accordingly.

(5) Table/room preference information: The organizer can decide how he wants to break up larger events by specifying a maximum number of people per table or room (e.g., the maximum table size for lunch is 6, so a 30 person event would be broken into 5 tables). In some embodiments, the organizer can also specify how tables are broken up (e.g., tables should have members from the same industry on the 1st Wednesday of the month; but members from the same functional expertise on the 3rd Wednesday of the month). In some implementations the organizer provides this information to the scheduling server 106, and the scheduling server schedules events accordingly.

(6) Post event survey information: In some embodiments, organizers are provided with the option to provide questions to pose on the automated post event survey. In some embodiments the organizer is provided with the option to flag some questions to be included in feedback reports to restaurants or members. An example of an event survey is shown in FIG. 5C. In some implementations the organizer provides this information to the scheduling server 106, and the scheduling server 106 generates feedback reports for restaurants based on participants' responses to questions accordingly.

(7) Group locations: An organization may have members in multiple locations. The organizer can specify a different schedule for different locations. For example the organizer might specify that lunches should be arranged for members near Berkeley on the 1st Wednesday of each month, and that lunches should be arranged for members near Palo Alto on the 3rd Wednesday of each month. In some implementations the organizer provides this information to the scheduling server 106, and the scheduling server 106 schedules events accordingly.

(8) Specify hosts: In some embodiments, an organizer is provided with the option to designate one or more hosts. Hosts are optionally given responsibilities such as generating interest in the event, tailoring a specific event to members' needs, or being present to receive event guests, answer questions, and guide discussions. Hosts are optionally designated on an event basis, or for a particular geographic area. In some implementations the organizer provides this information to the scheduling server 106, and the scheduling server 106 sends requests to and receives instructions from hosts accordingly.

(9) Privacy information: The organizer can decide whether they want to approve members before they can be invited to events or if membership is open. For groups with private membership, the organizer optionally provides text that explains the approval process. Membership restrictions are optionally also be defined by things like the email domain of the user (e.g., only users with an email address ending with @companyxyz.com are eligible to become members). The organizer can also decide whether his group should be discoverable by anyone (e.g., searchable or promoted on the home page), or only available to those who know a special link to access the group. In some implementations the organizer provides this information to the scheduling server 106, and the scheduling server 106 registers new members accordingly.

(10) Registration information: In some embodiments, the group organizer is provided with the option to provide profile information about himself such as his name, email address, phone, LINKEDIN profile, FACEBOOK profile, TWITTER handle, work address, home zip code, and privacy preferences. In some implementations the organizer provides this information to the scheduling server 106, and the scheduling server 106 provides this information to potential members of the group accordingly.

(11) Member information: In some embodiments, the organizer is given the option to provide information about his group members. For example, if the organizer already operates an online group and has the names, email addresses, job titles, or other information about the members of that group, the organizer is provided with the option to upload this information to the scheduling server 106. FIG. 5L illustrates an example of an interface for an organizer to add information about group members. In some implementations the organizer provides this information to the scheduling server 106, and the scheduling server 106 updates member information for members of the group run by the organizer accordingly.

(12) Promoting the group: The organizer is also given a number of methods to use in order to drive members to join the new group, such as email invitations, posting to social networks, distributing a uniform resource locator (URL), or printing and posting physical posters. An example of options for inviting members to a group is shown in FIG. 5M. In some implementations the organizer provides this information to the scheduling server 106, and the scheduling server 106 invites invitees to join the group accordingly.

Once an organizer has created a group, the scheduling server 106 has enough information to begin planning events. The scheduling server 106 automatically generates events as described in the event automation section.

### Creating an Event

The second way an organizer can get started is to create an event. On the surface, this resembles fairly conventional event planning, but to one skilled in the art it will be apparent that there is considerably more going on. The organizer is provided with the option to provide one or more of the following details: Who, When, Where.

(1) Who: An example of the WHO section of the meeting create page is illustrated in FIG. 5D. The organizer or host is provided with the option to select participants to invite from among:

a. Email: The organizer can provide the email addresses of people to be included in the event. In some implementations the organizer provides this information to the scheduling server 106, and the scheduling server 106 schedules events accordingly.

b. FACEBOOK/LINKEDIN: The organizer can connect to his or her social network accounts and can indicate the friends to be included in the event. In some implementations the organizer provides this information to the scheduling server 106, and the scheduling server 106 schedules events accordingly.

c. Prior events: In some embodiments, the organizer is provided with the option to schedule an event with any participant who the organizer was grouped with at a prior event. For example if, at a prior event, the organizer was seated at a table with four other people, those people could be invited to the event the organizer is organizing. Note that the prior event need not be affiliated with the same group that the current event is. In some implementations the organizer provides this information to the scheduling server 106, and the scheduling server 106 schedules events accordingly.

d. Group locations: Groups can be set up so that particular hosts or organizers have administrative rights over a particular geographic area. If the organizer of the current event has been given these administrative rights over one or more geographic areas for one or more groups, then the organizer has the ability to invite those group members who have listed an address in their profile which lies within those areas. In some embodiments, the scheduling server 106 optionally makes members available to be invited if the scheduling server 106 does not have an address for a particular group member.

e. Group members: In some embodiments, if the organizer has been given administrative rights over an entire group, then all the members of that group are available to the organizer to be included in the event.

f. Followers: In some implementations, the scheduling server 106 provides a means for users to “follow” one another. For example, if user A had been seated at a table with users B, C, and D, but had a particularly noteworthy conversation with C, then user A can tell the scheduling server 106 that they want to follow user C. This would mean that user A would be informed of meals which user C plans to attend. On the event creation page, the scheduling server 106 optionally makes both the users followers as well as the users that the organizer is following available to be included in the event. In some embodiments, requests from one user to “follow” another user are subject to subsequent approval by the other user. In some embodiments (e.g., where follow requests are not subject to subsequent approval) a respective user has the option to restrict what information other users can follow and specify which users or groups of users can follow the respective user without prior approval (e.g., only members of groups that the respective user has joined or only users that the respective user has identified as “friends” can follow the activities of the respective user).

g. Filters: The organizer optionally filters the available list of users by any number of methods. For example, the organizer is provided with the option to filter by address, asking that the scheduling server 106 not include any user who does not have an address within 10 miles of a given location. The organizer is provided with the option to filter by group affiliation. In particular, the organizer is provided with the option to decide to only include people who have already joined the XYZ club. An example of a filter applied by scheduling server 106 to the WHO list is shown in FIG. 5E.

h. Search: The scheduling server 106 allows organizers to search for keywords present in users' profiles. The scheduling server 106 searches through all available information on users for keyword matches. For example, if a user has connected their LinkedIn profile in which the user has listed “Educator” as a profession, then this user appears in the results list when the organizer searches for “Educator.”

i. Link: The organizer also has the option to provide a URL to people who may be interested in attending a meal. The organizer is provided with the option to distribute this URL through email, a website, printed materials or other means. Thus instead of determining who will be invited up front, the event can be created and users can join the event by visiting a URL.

(2) When: FIG. 5F: illustrates an example of how times and dates are selected.

a. Event type: The organizer selects the type of event that he is creating. For example, the organizer would select “Breakfast” if he is organizing a breakfast. In some embodiments, an “other” option is available which allows the organizer to create custom events.

b. Time selection: The organizer indicates the time that the event is to start.

c. Ending time: In some embodiments, the organizer is provided with the option to customize the ending time.

d. Date guidance and selection: In some embodiments, based on the time of the event and the list of people to be included in that event, the scheduling server 106 provides guidance around available dates. A calendar is displayed whose specific dates indicate whether more or fewer members are available on those dates. As one example, the organizer is setting up a lunch. If the scheduling server 106 knows that among users to be invited, most of them joined one or more groups that feature lunches on the 2nd Wednesday of the month, then the scheduling server 106 knows that these users are expecting to be invited to a lunchtime meal on the 2nd Wednesday of the month. The calendar might display a green background for the 2nd Wednesday of the month to indicate that the users have this expectation. However, if the scheduling server 106 is aware that many of the users have already accepting a competing event for the 2nd Wednesday, then, in some situations, the calendar displays a red background for the 2nd Wednesday to indicate that many users are not available.

(3) Where: FIG. 5G illustrates an example of how location information is collected.

a. Prepaid option: The organizer is provided with the option to choose to require prepayment for his event, which is available when the scheduling server 106 is integrated with a venue to make this option available. In some embodiments, when an event requires prepayment, then attendees pay for services upfront in order to accept the event. For example, if a lunch event is being held at a restaurant, then an attendee might be required to prepay for their meal before they are allowed to accept the event. There are many benefits for hosting an event where prepayment is required: (a) the ratio of actual attendees to people who accepted the event is typically much higher since the participants have made a monetary commitment to attend, and (b) participants do not need to split a bill at the event. In some embodiments, when an organizer selects this option then scheduling server 106 filters the list of available venues to only include those for which there is prepaid support.

b. Search by name or near a location: The organizer is provided with the option to search for venues by name and/or near a particular location at scheduling server 106.

c. Search near a midpoint: The organizer is provided with the option to select the midpoint of all selected users as that starting location to search for available venues. In some implementations, the scheduling server 106 calculates the midpoint based on the users selected by the organizer that have a known address.

d. Search near a specific user: The organizer is provided with the option to choose a location near a specific user.

e. Search near a group location: In some implementations, groups are active only in certain geographical areas. These group locations optionally appear as an option for the organizer to use as the center point for a venue search.

f. Custom location: An organizer is provided with the option to specify his own custom location. For example, if the organizer has access to a private café on the campus of a large company, that can be entered as a custom location.

g. Location request: The organizer is provided with the option to use the interface to make a request to the scheduling server 106 to find an appropriate venue in a given location based on information provided by the organizer, invitees and/or participants, as described above.

h. Venue embodiments: In some embodiments, a venue is a restaurant, such as a restaurant with table service and that accepts reservations. However, a venue may be any location appropriate for people to gather, such as a bar, park, or other gathering facility.

i. Auto selection: In some implementations, for as long as a venue has not yet been selected, the scheduling server 106 attempts to automatically select an appropriate location and venue based on the locations of who has been invited and any explicit or implicit preferences gleaned from the organizer. For example, if the organizer has historically chosen lower cost venues and has invited members in the downtown Chicago area, then the scheduling server 106 automatically finds and suggests a lower cost venue in downtown Chicago.

j. Location selection delegation: In some embodiments, the organizer is given the option to specify that one or more users should be given the choice of selecting a location for the event (e.g., the organizer can delegate responsibility for selecting the location to one of the other participants in the event).

k. Venue filtering: In some embodiments, the scheduling server 106 only displays venues that are appropriate for the time selected. For example, if the organizer has selected a breakfast time, the scheduling server 106 only displays venues that are appropriate for breakfasts. In some embodiments, the organizer is optionally able to select a price range that is appropriate for his event. In this case, the scheduling server 106 only displays venues whose services fall inside that price range.

l. Pricing: Where possible, the scheduling server 106 displays pricing information about venues in the search results. The price is optionally a range or a single number, and optionally includes components such as an entrée price, the price of a drink, tip, tax, the organizer's or group's fee, and a fee charged by the scheduling server 106.

4) Preview: The organizer is optionally given the opportunity to customize or adjust what his invitation looks like. FIG. 5H illustrates an example of an interface for creating a new meeting.

a. Introductory text: The text is preset to whatever the organizer wrote for whatever was last used for this group at a respective location selected for the event. In some situations (e.g., if a prior introductory text for the particular group at the respective location is unavailable), the scheduling server 106 defaults to whatever the organizer last wrote when planning any event. And in some situations, if this information is not available, the scheduling server 106 uses default text. In some embodiments, the scheduling server 106 gives the organizer the opportunity to edit this text.

(5) Advanced options: The organizer is optionally given additional options to select when planning his event. FIG. 5I shows an example of additional options on the “create meeting” page.

a. Maximum number of attendees: The organizer is provided with the option to choose to limit the number of attendees who can join an event.

b. Minimum number of attendees: The organizer can decide on a minimum number of acceptances required for an event to take place. In the event that fewer than the minimum number of attendees joins, then the event is cancelled with cancellation notices going out to those who had accepted the event.

c. Publication: The organizer is provided with the option to decide whether his event is open for anyone to attend or just those that he chooses to invite.

d. Organizer fees: The organizer is provided with the option to decide to include a fee for each participant.

e. Decide when to send invitations: The organizer is provided with the option to choose to schedule the sending of his invitations for a later date and time.

f. Table topics: The organizer is provided with the option to choose to set up table topics in which participants declare their interest at the time of acceptance. FIG. 5J illustrates an example of assigning tables to participants based on interests associated with the users (e.g., interests declared by users or known by the scheduling server 106 based on prior actions by the users).

g. Subscription option: The organizer is provided with the option to indicate that participants must have an active subscription to the group in order to participate in this event.

h. Deadlines: The organizer is provided with the option to customize the deadline by which participants must accept or decline their participation.

i. Decide which notifications go out: In some embodiments, the organizer is provided with the option to decide which notifications should be sent out and when. Possibilities include invitations, deadline reminders, acceptance notifications (e.g., “You have accepted the event on 4/24”), confirmations (e.g., “The event on 4/24 is now continued since enough attendees have accepted”), text reminders (e.g., “Your meeting starts in 1 hour. This link provides the address and driving directions”), or post-event survey (e.g., “Please answer a few questions about your event”).

j. Pricing transparency: For events where a payment is required by the organizer, the organizer is provided with the option to choose whether to use opaque, semi-transparent, or transparent pricing. Transparent pricing breaks out tip, tax, entrée, drink, event pricing, or other line item details, as well as the costs for each (e.g., “The total price is $12, broken out as follows: entrée . . . $8, tax . . . $2, tip . . . $2.”). Semi-transparent pricing includes the line items, but does not display the line item cost (e.g., “The total price is $12 which includes an entrée, drink, and dessert”). Fully opaque pricing hides all line item details and only displays the total price (e.g., “The total price is $12.”). FIG. 5P shows an example of fully opaque pricing.

(6) Auto generation of future events: In some embodiments, the organizer is given an option to have the scheduling server 106 automatically schedule future events similar to the event that has just been created. This may involve creating a new group, it may involve creating a schedule for a particular location for a group, or it may involve creating a single schedule for the entire group.

(7) Guided event planning: In some embodiments, the organizer is optionally given a link to have the scheduling server 106 automatically create an event or a tentative event for a particular group of people. FIG. 5K shows an example of an interface for guided planning of an event. Guided event planning follows the same process described in the event automation section.

(8) Promoting the event: Once an organizer has created an event, the organizer is given options for promoting his event. Similar to the case for promoting the group, the organizer has the option to email invitations, post to social networks, or distribute a URL. FIG. 5O shows an example of an interface for promoting an event.

(9) Splitting tables: In many cases, it is desirable to have smaller tables in order to facilitate more intimate discussions. If an event has more attendees than what the organizer requested for their table maximum, the organizer optionally receives a suggestion to split tables from the scheduling server 106. The interface allows an organizer to view information about each participant and place participants at tables according to whatever methodology the organizer chooses. In some embodiments, the scheduling server 106 does this automatically based on similar or related attributes found among the users' answers to the group's questionnaire, the users' answers to other groups' questionnaires, the users' profile information, the users' social network profile information, or other data sources. In some embodiments, the scheduling server 106 optionally provides guidance to the organizer for splitting large groups based on this information. In some embodiments, event participants are split into groups other than tables (e.g., split across rooms, selected for teams, chosen to wear a specific colored wristband, etc).

### Event Automation

For any group that has set up a group schedule, the scheduling server 106 works to generate tentative events automatically. Additional information concerning automatically generating tentative events is described above with reference to FIGS. 4A-4B. In some embodiments, the process of generating tentative events automatically works as follows:

(1) Selecting members: The scheduling server 106 selects users from that group based on where there are minimum densities of members where members have been invited to the fewest events. In some instances, such as with new groups, the scheduling server 106 does not have enough information about the group's members. In these cases the scheduling server 106 begins the planning process with the next step.

(2) Selecting a general location: In some embodiments, based on the locations of the selected members, the scheduling server 106 selects a location. In some embodiments, if there is insufficient information about the members or their locations, then the scheduling server 106 selects a location based on any known group locations if at least one was provided by an organizer for the group. In some embodiments, in the case when there is insufficient information about the group's locations, then the scheduling server 106 omits the location and proceed to the next step. In some embodiments the scheduling server 106 employs this logic in a different order.

(3) Selecting a date: In some embodiments, based on what the scheduling server 106 knows of the availability of the selected members, the scheduling server 106 selects a date. If there is insufficient information available about members' availability, then the scheduling server 106 selects a date based on any schedule information submitted by an organizer for the specific group location. If there is insufficient information available about the organizer's desired schedule for the specific group location, then the scheduling server 106 selects a date based on the schedule set by the organizers for the group as a whole. In some embodiments the scheduling server 106 employs this logic in a different order.

(4) Selecting a time and event description: In some embodiments, based on explicit and implicit preferences of the organizer, the scheduling server 106 selects a time and event type. For example, if the group was set up for breakfast events and the organizer has changed the start time from the default of 8:00 am to 7:30 am, then the scheduling server 106 selects a time of 7:30 am and a description of “breakfast” for the event.

(5) Selecting a specific location: In some embodiments, based on the information about the general location, the time of the event, and explicit and implicit preferences of the organizer, the scheduling server 106 selects a specific venue.

(6) Selecting introductory text: In some embodiments, the scheduling server 106 defaults to text used for prior events at the same location. In some implementations, if no text used for prior events exists, the scheduling server 106 uses text used at any meeting for the same group. Otherwise, the scheduling server 106 uses a predefined default text that is not associated with the group or organizer.

(7) Creating a preview: In some embodiments, based on text used for previous events, the scheduling server 106 generates a preview of the event. This preview is sent to the appropriate organizers to review. In some embodiments, previews are sent to the hosts for the particular group location under which the specific event falls. If there are no hosts for the group location, then the preview is sent to the group's administrators or organizers. If there is no response from the organizers within a given number of days and there isn't any missing information for the event (e.g., an unknown location), then the event will automatically be published and invitations will automatically be sent to participants. The organizer optionally previews the event and may choose to send the invitations out, to make edits before invitations out, or to cancel the event.

### Member Experience when Joining a Group

In some embodiments, when a member joins a group, the process includes one or more of the following steps:

(1) Member questionnaire: The member completes the group's questionnaire if the organizer provided instructions to scheduling server 106 to set up a group questionnaire. FIG. 5B shows one example of a group questionnaire. In some embodiments, if the member is also new to the scheduling server 106, then the member is asked to provide basic profile information such as an email address and physical work address.

(2) Approval status: In some implementations, if the group was set up as a private group requiring that members be approved by organizers, then a message is presented to the prospective member that their application is pending. In such implementations, the user will not be allowed to continue in this group sign up process until the organizer has approved the user's application.

(3) Subscription fees: In some embodiments, f the group organizer has set the group up such that members must pay a subscription fee to join, then the user is presented with the subscription options and a page where the user is given the option to enter their payment information. Subscription options may vary. For example, a subscription is $10 per year to be invited to all events, or $5 per quarter to be invited to all events during the quarter, or $2 per acceptance.

(4) Upcoming events: In some embodiments, if there are upcoming events that are near the member's location, then those events are presented to the member to see if they would like to accept their first event, as described in greater detail below.

(5) Promoting the group: In some implementations, similar to the experience for organizers, users are given the opportunity to tell their friends or connections about the group. Promotion of the group can take place through email, by distributing a URL, via social networks, or through other channels.

(6) Placeholders: In some embodiments, the scheduling server 106 sends placeholders to the user's calendar to hold any relevant dates for the group that the user just joined. For example, if the group is set up such that the Santa Monica location has breakfasts on the 1st Wednesday of each month, and the user signed up with an address near Santa Monica, then the scheduling server 106 would send a multipart email with an iCal or vCal section to the user which would result in the event series being placed tentatively on the user's electronic calendar, assuming that the user's email address is connected with an electronic calendar such as OUTLOOK, APPLE ICAL, or GOOGLE CALENDAR. In some embodiments, a member is optionally given the option of connecting their calendar service to the scheduling server 106 such that the scheduling server 106 can read the user's availability, post placeholders and events, or both. For example, GOOGLE offers an OAuth based login where users can grant these types of permissions to an application. In some embodiments, the iCal section are optionally included in an email as an attachment.

### User Experience when Accepting an Event

In some embodiments, when a user joins a group, she is effectively agreeing to receive invitations to that group's events. This is one way in which users learn about upcoming events. Users may also learn about upcoming events without joining the group by browsing published events on a website hosted by the scheduling server 106 or by seeing a link to the event through some other means. In some embodiments, when a user accepts an event, the process includes one or more of the following steps:

(1) Receiving an invitation from the scheduling server 106: In some embodiments, if the user has signed up with a group to receive invitations then the scheduling server 106 sends the user an email. In cases where the scheduling server 106 already has a payment instrument on file for the user and there is no additional information required from user, then the scheduling server 106 optionally sends a request to the user's calendar in any number of ways, including as an iCal/vCal section in a multipart email, as an attachment to an email, or through a programmatic connection to the user's calendar.

(2) Responding to the invitation: If the user received an invitation through some means that is connected to the user's calendar, then the user has the option of responding to the invitation by simply accepting the event from their calendar. In some embodiments, in cases where the event requires prepayment, then the acceptance can be used as a proxy for payment instructions for the event, as described in greater detail below with reference to method 600.

(3) Visiting the event page: In some implementations, all invitations to events contain links to the event page. Additionally, users are optionally given a link to the event page through other means such as a newsletter from the organizer. FIG. 5N illustrates an example of an event page. In some embodiments, the event page includes one or more of the following components:

a. User actions: In some embodiments, users who have not accepted see an option to attend the event. In some implementations, those users who are not yet members of the group see an option to decline, but to join the group so as to be invited to future events, while those users who have already accepted see an option to decline instead. Note that, in some embodiments, the available actions displayed on the event page are adjusted based on things like whether the event has passed, or whether the venue has already downloaded the event roster. For example, if a user visits the event page four hours prior to a dinner, but the restaurant has already downloaded the roster of attendees, then the user is not given the option to join the event since the restaurant would not be aware that the user will attend.

b. Pricing: In some embodiments where events require payment, the price and any options are displayed on the event page.

c. Meeting topics: In some implementations, if the organizer has set up meeting topics for the event, the user is presented with the option of selecting one.

(4) Logging in: In some embodiments, if the user is unknown to the scheduling server 106, then scheduling server 106 asks for a log in. FIG. 5R shows an example of a sign up page where the scheduling server 106 requests this information. The example shown in FIG. 5R includes multiple options for logging in, including an email login as well as logins through popular social media services.

(5) Providing payment information: In some embodiments, if the scheduling server 106 does not have a payment instrument on file for the user, then the scheduling server 106 requests one from the user. In some cases, groups can be set up such that a user is enabled to check a box to prevent their payment information being saved beyond the event which the user is currently accepting.

(6) Promoting the event: In some embodiments, similar to the experience for groups, users are given the opportunity to tell their friends or connections about the event that they just accepted. Promotion of the event by a user can take place through email, by distributing a URL, via social networks, or through other channels.

(7) Missing information: In some embodiments, if the scheduling server 106 is missing any information about the user, then the scheduling server 106 prompts the user to provide that information. For example, if a group organizer added a new question to the group questionnaire which the user has not yet answered, then this question would be presented to the user.

(8) Acceptance notification: In some embodiments upon acceptance of the event by the user, the scheduling server 106 sends the user an email reminding the user that they have accepted this event. In some embodiments, this email is a multipart email with an iCal or vCal part that posts the event into the user's calendar. Similar to other calendar integrations described herein, the event is optionally posted by the scheduling server 106 using an email attachment or other programmatic means. FIG. 5T shows an example of a calendar-based acceptance notification. In some implementations, if an organizer specified that the scheduling server 106 should not send acceptance notifications, then these notifications would not be sent.

(9) Confirmations: In some embodiments, the scheduling server 106 considers an event “confirmed” if the minimum number of participants has been reached, and the scheduling server 106 sends confirmation messages to those participants that have accepted the event. The confirmation message optionally contains information such as who else will be attending, and any special instructions for the event (e.g., “proceed to the front of the line and tell the bouncer you are with the United States Patent and Trademark Office to be admitted without charge.”) In some embodiments, the scheduling server 106 includes additional information directly in the notification or includes a link to the profiles of other participants, such as the other participants' LINKEDIN profiles or FACEBOOK profiles. In some embodiments, the confirmation message includes information about the participants taken from the group's questionnaire. In some embodiments, the confirmation message includes or links to a compatibility or common interest compilation which informs a user about how they are connected to some or all of the other participants.

(10) Pre-event text: In some embodiments, between ten minutes and two hours before the event, the scheduling server 106 sends a text reminder to users who have accepted. In some implementations, the text message contains a link to a map and directions, and a list of the other attendees, as well as a means to contact the other attendees should the user need to contact them.

(11) Post-paid items: In situations where the scheduling server 106 has a valid payment instrument on file, the scheduling server 106 optionally provides the ability for a user to order additional items at the venue and have those items charged to her account. For example, a participant might order a bottle of wine at a restaurant. The restaurant need only note who ordered the bottle of wine and how much it cost, and then report this information back to the scheduling server 106, which charges the user an appropriate amount.

(12) Post event survey: In some embodiments, the event planning service sends a survey request to event participants to collect feedback about an event. FIG. 5C shows an example of a post event survey.

### Experience for Venues

Reserving space: In some embodiments, the scheduling server 106 sends a notification to the selected venue indicating an estimated number of participants and any special requirements. In some embodiments, this notification is an automated email sent to a contact at the venue, an automated fax sent to the venue. In some embodiments, this notification is an interaction through a 3rd party service that handles reservations such as OPENTABLE. In some embodiments, the venue is assigned a URL by the scheduling server 106 that can be used by the venue to track attendance and any special requests. If the event involves line item menu ordering, then the venue can track the current status of those orders as well. The information optionally contains feedback from surveys completed by users from previous events held at the same venue for questions pertaining to the venue.

Final roster and information: Om some embodiments, the scheduling server 106 sends information to the venue several hours prior to the event with finalized information. The scheduling server 106 optionally sends this information via email or fax, and/or sends a URL where the restaurant can go to download this information. In some embodiments, information about the event sent to the venue includes one or more of:

(1) Roster/pre-ordered items: In some embodiments, the information includes the full roster of who will be attending, any special requests, and any pre-ordered menu items is included with the final information.

(2) Table tents: In some situations (e.g., when the organizer has specified that table tents are required for the event), the scheduling server 106 includes these such that the venue can print the table tents and place them on the tables. Typically table tents would include the specific names of participants to be seated at a particular table, and instructions to guests as to what to do if they showed up without reserving beforehand. The table tents optionally also include introductory text about each participant so that attendees are able to glance at the table tent to learn about the other attendees at their table. In some implementations, the introductory text includes the users' answers to a question from the group's questionnaire.

(3) Survey information: In some embodiments, the information provided to the venue contains feedback from surveys completed by users from previous events held at the same venue for questions pertaining to the venue.

(4) Payment arrangements: In some implementations, for prepaid events, the information for the venue includes details around how the venue is paid by the scheduling server 106 for food or services consumed. In many situations, this involves providing a credit or debit card instrument for the venue, and optionally include a one-time use debit card. However, other arrangement can also be made, such as invoicing and payment through checks or other means.

(5) Instructions: In some embodiments, the information for the venue also contains instructions for the staff on how to manage the event and handle special situations related to the event.

### Other Features

Menu options: In some embodiments, for some venues, the scheduling server 106 stores item-level details that allow users to pre-order specific items. FIG. 5Q shows an example of an event invitation with item-level pricing details and options.

Logging in: In some embodiments, the scheduling server 106 employs several methods to determine the identity of a user. As one example, each link sent to a user is unique and is matched with information about the user and the security limits associated with that link. In this example, clicking a link automatically logs a user in (auto login) if the originating link came from a known source, such as an email that was only sent to a single user. However, in some embodiments, if an email is more likely to be forwarded to other users, then the scheduling server 106 gives the links in that email a higher security threshold meaning that a user will have fewer actions available to her when logged through this link mechanism. In contrast, in this example, if the email is likely to only be viewed by a single user, then the scheduling server 106 gives the links a lower security threshold meaning that the user will have more permissions and actions available to her after she clicks the link.

In some embodiments, in cases where the scheduling server 106 is unsure whether a user has forwarded a message containing secure links to another user, such as when the scheduling server 106 serves an html page to a user that does not appear to have ever had a cookie placed from the scheduling server 106, then the scheduling server 106 prompts the user to confirm her identity. FIG. 5U shows an example of an auto login link opened by an unknown user. In this example, if the user answers that they are not the person, then the auto login feature for that particular link is revoked. Thus, in some embodiments, if one user forwards an auto login link to many people, only one of the recipients needs to decline the identity challenge, and the auto login capability for that link is revoked by the scheduling server 106 for all the users to whom that link was forwarded.

Multiple user locations: In some embodiments, users are provided with the option to specify one or more locations to allow the scheduling server 106 to decide which events are geographically relevant to them. FIG. 5V shows an example of a user profile with multiple location support. In some embodiments, users are provided with the option to specify whether they will only be in a particular location for certain dates. In some embodiments, users are provided with the option to specify a radius that they are willing to travel around a particular location. In some embodiments, users are provided with the option to specify whether an address is a work address or home address, which is used by the scheduling server 106 to infer whether a given event is a good match for lunch, dinner, or breakfast.

Game mechanics: In some embodiments, game mechanics are employed in order to increase engagement. For example, the game mechanics can include one or more of: allowing users to earn points for actions such as attending meals or answering survey questions. In some implementations, users with a large number of points can be given special badges or statuses highlighted on web pages or at events. For example, confirmation emails and table tents might read that “John Doe is the lunch captain today”.

Group locations: In some embodiments group locations are automatically detected by the scheduling server 106. In some embodiments, a k-means clustering or nearest-neighbor algorithm is used by scheduling server 106 to produce groups of members near one another. In some implementations, the number of clusters optimized for can be adjusted based on minimum and maximum desired cluster densities.

Address: As used herein, an address is used to refer, in general to anything that provides at least a rough approximation of a user's or group's location, such as a street address, intersection, zip code, city or an IP address.

### Payment Approval Using Electronic Calendar Objects

FIGS. 6A-6C include a flowchart representing a method 600 for authorizing payments, according to certain embodiments. Method 600 is, optionally, governed by instructions that are stored in a non-transitory computer readable storage medium and that are executed by one or more processors of one or more servers (e.g., scheduling server 106, FIG. 2). Each of the operations shown in FIGS. 6A-6C typically corresponds to instructions stored in a computer memory or non-transitory computer readable storage medium (e.g., memory 206 of scheduling server 106 in FIG. 2). The computer readable storage medium optionally includes a magnetic or optical disk storage device, solid state storage devices such as Flash memory, or other non-volatile memory device or devices. The computer readable instructions stored on the computer readable storage medium optionally includes one or more of: source code, assembly language code, object code, or other instruction format that is executed or interpreted by one or more processors. In various embodiments, some operations in method 600 are optionally combined and/or the order of some operations are optionally changed from the order shown in FIGS. 6A-6C.

Scheduling server 106 obtains (602) a payment instrument associated with a user. For example, when the user registers with scheduling server 106, scheduling server 106 prompts the user to provide credit card account information, bank account information or information enabling payments to be processed with a payment intermediary. This payment instrument is for use in processing payments authorized by the user by accepting an electronic calendar object. In some embodiments, prior to sending the electronic calendar object to the client (e.g., client 102) associated with the user, scheduling server 106 receiving (604) preapproval from the user to process payments corresponding to fees associated with electronic calendar object using the payment instrument in response to acceptance of an electronic calendar objects.

In some embodiments, prior to sending the electronic calendar object, the scheduling server 106 receives (606) event preference information from a client associated with the user, where the event preference information includes contact details for one or more contacts of the user and scheduling details indicating that the user would like to schedule a plurality of events occurring on different dates in accordance with the periodic interval. Additionally, in some of these embodiments, after receiving the event preference information and prior to sending the electronic calendar object, the scheduling server 106 sends (608) a placeholder event series to a client associated with the user, where the placeholder event series includes a plurality of respective proposed events on different respective dates selected in accordance with a periodic interval (e.g., as described in greater detail above with reference to FIGS. 4A-4B).

The scheduling server 106 sends (610), to a client (e.g., client 102) associated with the user, an electronic calendar object corresponding to a respective date, where the electronic calendar object is associated with a fee (e.g., an event fee for an event, a bill payment with a due date on the respective date, or another amount owed by the user). In some embodiments, the electronic calendar object includes (612) an indication that acceptance of the electronic calendar object will constitute authorization to process a payment corresponding to the fee using the payment instrument. For example, the electronic calendar object is an iCal part that includes the text “accepting this invitation will authorize payment of $25.00 to your credit card ending in x0123.”

In some embodiments, the electronic calendar object includes (614) one or more selectable options that affect a total amount of the fee (e.g., meal choice options such as those shown in FIG. 5Q). In some embodiments, the electronic calendar object includes (616) an invitation to an event, the respective date is an event date on which the event is scheduled to occur, and the fee is an event fee associated with the event. For example, the electronic calendar object is an invitation to a lunch including the user on Apr. 25, 2012 at a local café, where lunch costs $12. In some embodiments, the electronic calendar object is (618) an update to a respective proposed event in a placeholder event series.

In some embodiments, the event fee is based on (620) default choices determined based on predetermined user preferences. (e.g., user preferences explicitly indicated by the user in a user profile or user preferences determined based on historical information about options selected by the user) For example, “clicking accept on your calendar will preorder the same type of dish that you chose last time (vegetarian) and will authorize payment on your payment instrument.” In some embodiments, the event fee includes (622) the price of a prepaid meal that will be provided to the user at the event. In some embodiments, the event fee includes (624) the price of a prepaid drink that will be provided to the user at the event (e.g., at a happy hour event). In some embodiments, the scheduling server 106 determines whether a response has been received. In some implementations, in accordance with a determination that a response has not (626) been received before the respective time (e.g., the event time of the event), the scheduling server 106 forgoes (628) storing information indicating that the user has authorized the fee to be paid using the payment instrument.

In some situations event server receives a user response to the electronic calendar object, and in response to receiving the user response to the electronic calendar object the scheduling server 106 determines (632) whether the user response includes an acceptance of the electronic calendar object. In some embodiments, in accordance with a determination that the user response does not (634) include an acceptance of the electronic calendar object, the scheduling server forgoes (636) storing information indicating that the user has authorized the fee to be paid using the payment instrument.

In contrast, in accordance with a determination that the user response includes (640) an acceptance of the electronic calendar object, the scheduling server 106 stores (642) authorization information indicating that the user has authorized the fee to be paid using the payment instrument. In some embodiments, the respective date is a payment date (e.g., a day on which an event occurs or a day on which a bill is due) on which payment of the fee will be processed and the method further comprises, and in response to receiving the user response, the scheduling server 106 schedules (644) processing of the payment for the payment date, in accordance with the authorization information. Thus, in some embodiments, instead of processing the payment of the fee immediately upon receiving the authorization from the user, the scheduling server 106 schedules payment for a later point in time and at the later point in time will process the payment using a payment instrument associated with the user.

In some embodiments, in response to receiving the user response information, before the respective date, the scheduling server 106 verifies (646) the payment instrument (e.g., by processing a test payment or placing a hold on the payment instrument) and in accordance with a determination that the payment instrument is not valid (648), the scheduling server 106 sends (650) a communication to the user indicating that the payment instrument is not valid. For example, the communication could include one or more of: a request to update payment instrument information, a request to provide (652) a new payment instrument, or a request to visit a website hosted by the scheduling server 106 that enables the user to enter/update payment instrument information. In some embodiments, when a new or updated payment instrument is provided by the user in response to a request related to a particular event, the scheduling server 106 returns to operation 642, where authorization information is stored indicating that the user has authorized the fee to be paid using the new payment instrument. In some embodiments, if authorized by the user, the new payment instrument is stored for later use as a payment instrument for future events, so that the user can authorize payment for future events by accepting electronic calendar objects for the events.

In some embodiments, when the electronic calendar object includes an invitation to the event on the event date with the event fee, in accordance with a determination that a valid payment instrument for the user is not available at a predefined time (e.g., a time determined based on the event time, for example 1 day prior to the event time or 1 hour prior to the event time) the scheduling server 106 sends (654), to a client associated with the user, an update to the event cancelling the event for the user. In some implementations, an event is canceled for a user when the event is canceled or the user's invitation to the event is cancelled/revoked/withdrawn and the calendar event is removed from the user's calendar. Thus, in some embodiments, if the user has not provided payment for an event that requires prepayment, the user is disinvited to the event.

In some embodiments, in accordance with a determination that the payment instrument is valid (656) after receiving the user response, the scheduling server 106 processes (658) a payment corresponding to the fee using the payment instrument, in accordance with the authorization information. In some embodiments, processing the payment is performed in response to (660) receiving the user response information. Thus, in some embodiments, as soon as the user accepts the invitation to the event a payment is processed by the scheduling server 106. In some embodiments, processing the payment is performed after (662) a date associated with the electronic calendar object. Thus, in some embodiments, payment of the event is not processed until a date close to the event (e.g., the day before, the day of or the day after the event). In some embodiments, processing the payment includes (664) capturing a credit card payment from a credit card account. In some embodiments, processing the payment includes (668) withdrawing a payment from a bank account. In some embodiments, processing the payment includes (670) receiving payment from a payment processing intermediary (e.g., Paypal or Google Checkout).

In some embodiments, when the electronic calendar object includes (672) an invitation to the event on the event date with the event fee, as described in greater detail above with reference to operation 616), in response to receiving the user response information, before the event has occurred, the scheduling server 106 verifies (674) the payment instrument and after the event has occurred, processing (676) a payment corresponding to the event fee using the payment instrument, in accordance with the authorization information. Thus, in some embodiments, the scheduling server 106 makes sure that the payment instrument is valid prior to the event but does not actually process a payment using the payment instrument until the user has attended the event.

In some embodiments, when the electronic calendar object includes (672) an invitation to the event on the event date with the event fee, as described in greater detail above with reference to operation 616), the event fee includes (678) a fixed portion and a supplemental portion. In these embodiments, the fixed portion is determined prior to the event, and the supplemental portion of the event fee is determined based on actions taken by the user at the event. Thus, in some embodiments, the user authorizes a fixed payment when accepting the invitation to the event but is able to make additions at the event (e.g., ordering another drink, side order, desert) and those additional costs will be factored into a single event fee and the scheduling server 106 processes the event fee including both the fixed payment and the additional costs after the user has attended the event.

In some embodiments, when the electronic calendar object includes (672) an invitation to the event on the event date with the event fee, as described in greater detail above with reference to operation 616), and before the event, the scheduling server 106 processing (680) a payment corresponding to the event fee. After the event, the scheduling server 106 also processes (682) a subsequent payment corresponding to a supplemental event fee determined based on actions taken by the user at the event (e.g., additional food and/or drinks ordered by the user at the event). Thus, in some embodiments, in these embodiments, when accepting an invitation a user authorizes two payments for the event, a first payment that occurs prior to the event and covers fixed costs of the event (e.g., a fixed price meal and organizers fee) and a second payment that occurs after the event and covers additional expenses incurred by the user (e.g., ordering a bottle of wine or a daily special). In some embodiment, the payment corresponding to the event fee and the subsequent payment are both processed using the same payment instrument (e.g., a credit card that the user has on file with the scheduling server 106).

It should be understood that the particular order in which the operations in FIGS. 6A-6C have been described are merely exemplary and are not intended to indicate that the described order is the only order in which the operations could be performed. One of ordinary skill in the art would recognize various ways to reorder the operations described herein. Additionally, it should be noted that details of other processes described herein with respect to method 400 (described herein with reference to FIGS. 4A-4B) are also applicable in an analogous manner to method 600 described above with respect to FIGS. 6A-6C. For example, the events, invitations and payments described above with reference to method 600 optionally have one or more of the characteristics of the various events, invitations and payments described herein with reference to method 400. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for payment authorization, comprising:
at a server system including one or more processors and memory:
obtaining a payment instrument associated with a user;
sending, to a client associated with the user, an electronic calendar object corresponding to a respective date, wherein the electronic calendar object is associated with a fee;
receiving a user response to the electronic calendar object; and
in response to receiving the user response to the electronic calendar object:
in accordance with a determination that the user response includes an acceptance of the electronic calendar object, storing authorization information indicating that the user has authorized the fee to be paid using the payment instrument.

2. The method of claim 1, further comprising, in response to receiving the user response to the electronic calendar object:
in accordance with a determination that the user response does not include an acceptance of the electronic calendar object, forgoing storing information indicating that the user has authorized the fee to be paid using the payment instrument.

3. The method of claim 1, further comprising, in accordance with a determination that a response has not been received before the respective time, forgoing storing information indicating that the user has authorized the fee to be paid using the payment instrument.

4. The method of claim 1, further comprising, after receiving the user response, processing a payment corresponding to the fee using the payment instrument, in accordance with the authorization information.

5. The method of claim 4, wherein processing the payment is an action selected from the set consisting of: capturing a credit card payment from a credit card account; withdrawing a payment from a bank account; and receiving payment from a payment processing intermediary.

6. The method of claim 4, wherein processing the payment is performed in response to receiving the user response.

7. The method of claim 4, wherein processing the payment is performed after a date associated with the electronic calendar object.

8. The method of claim 1, further comprising, prior to sending the electronic calendar object to the client associated with the user, receiving preapproval from the user to process payments corresponding to fees associated with electronic calendar object using the payment instrument in response to acceptance of an electronic calendar objects.

9. The method of claim 1, further comprising:
in response to receiving the user response information, before the respective date, verifying the payment instrument; and
in accordance with a determination that the payment instrument is not valid, sending a communication to the user indicating that the payment instrument is not valid.

10. The method of claim 1, wherein the electronic calendar object includes an indication that acceptance of the electronic calendar object will constitute authorization to process a payment corresponding to the fee using the payment instrument.

11. The method of claim 1, wherein the electronic calendar object includes one or more selectable options that affect a total amount of the fee.

12. The method of claim 1, wherein:
the respective date is a payment date on which payment of the fee will be processed; and
the method further comprises, in response to receiving the user response, scheduling processing of the payment for the payment date, in accordance with the authorization information.

13. The method of claim 1, wherein:
the electronic calendar object includes an invitation to an event;
the respective date is an event date on which the event is scheduled to occur; and
the fee is an event fee associated with the event.

14. The method of claim 13, further comprising:
in response to receiving the user response information, before the event has occurred, verifying the payment instrument; and
after the event has occurred, processing a payment corresponding to the event fee using the payment instrument, in accordance with the authorization information.

15. The method of claim 13, wherein:
the event fee includes a fixed portion and a supplemental portion;
the fixed portion is determined prior to the event; and
the supplemental portion of the event fee is determined based on actions taken by the user at the event.

16. The method of claim 13, further comprising:
before the event, processing a payment corresponding to the event fee; and
after the event, processing a subsequent payment corresponding to a supplemental event fee determined based on actions taken by the user at the event.

17. The method of claim 13, wherein the event fee is based on default choices determined based on predetermined user preferences.

18. The method of claim 13, further comprising, in accordance with a determination that a valid payment instrument for the user is not available at a predefined time sending, to a client associated with the user, an update to the event cancelling the event for the user.

19. The method of claim 13, wherein the event fee includes the price of a prepaid meal that will be provided to the user at the event.

20. The method of claim 13, wherein the event fee includes the price of a prepaid drink that will be provided to the user at the event.

21. The method of claim 13, further comprising, prior to sending the electronic calendar object, sending a placeholder event series to a client associated with the user, wherein the placeholder event series includes a plurality of respective proposed events on different respective dates selected in accordance with a periodic interval.

22. The method of claim 21, wherein the electronic calendar object is an update to a respective proposed event in the placeholder event series.

23. The method of claim 21, further comprising, prior to sending the placeholder event series, receiving event preference information from a client associated with the user, wherein the event preference information includes contact details for one or more contacts of the user and scheduling details indicating that the user would like to schedule a plurality of events occurring on different dates in accordance with the periodic interval.

24. A server system, comprising:
one or more processors;
memory; and
one or more programs, wherein the one or more programs are stored in the memory and are configured to be executed by the one or more processors, the one or more programs comprising instructions for:
obtaining a payment instrument associated with a user;
sending, to a client associated with the user, an electronic calendar object corresponding to a respective date, wherein the electronic calendar object is associated with a fee;
receiving a user response to the electronic calendar object; and
in response to receiving the user response to the electronic calendar object:
in accordance with a determination that the user response includes an acceptance of the electronic calendar object, storing authorization information indicating that the user has authorized the fee to be paid using the payment instrument.

25. A non-transitory computer readable storage medium storing one or more programs, the one or more programs comprising instructions, which when executed by a computer system with one or more processors, cause the computer system to:
obtain a payment instrument associated with a user;
send, to a client associated with the user, an electronic calendar object corresponding to a respective date, wherein the electronic calendar object is associated with a fee;
receive a user response to the electronic calendar object; and
in response to receiving the user response to the electronic calendar object:
in accordance with a determination that the user response includes an acceptance of the electronic calendar object, store authorization information indicating that the user has
authorized the fee to be paid using the payment instrument.
